(19) United States
(12) Patent Application Publication
(10) Pub. No.: US 2026/0128765 A1
(43) Pub. Date: May 7, 2026

(54) DYNAMIC MIMO AND CARRIER AGGREGATION COMMUNICATION CONFIGURATIONS

(71) Applicant: QUALCOMM Incorporated, San Diego, CA (US)

(72) Inventors: Sai Laxman SAMBARAJU, Hyderabad (IN); Shat PRATEEK, Agra (IN); Nazmul ISLAM, Littleton, MA (US); Raghuveer Ramakrishna Srinivas TARIMALA, Hyderabad (IN); Deeptanshu SHUKLA, Bangalore (IN); Anindya GUPTA, Bangalore (IN)

(21) Appl. No.: 18/935,421

(22) Filed: Nov. 1, 2024

(51) Int. Cl. H04B 7/0413; H04W 36/00

(52) U.S. Cl. CPC H04B 7/0413; H04W 36/00692

(57) ABSTRACT

Methods, systems, and devices for wireless communications are described. A user equipment (UE) may transmit a request message comprising a request to adjust one or more parameters associated with a multiple input-multiple output (MIMO) configuration, a carrier aggregation configuration, or both in accordance with one or more triggering parameters satisfying a threshold. The UE may receive a response message, wherein the response message indicates for the UE to adjust the one or more parameters in accordance with the request message. Additionally, or alternatively, the UE may receive a first control message indicating one or more timers associated with the one or more parameters, and may initiate, in accordance with receiving the first control message, a timer of the one or more timers in accordance with one or more triggering parameters satisfying a threshold. The UE may adjust the one or more parameters in accordance with expiry of the timer.

### FIELD OF TECHNOLOGY

The following relates to wireless communications, including dynamic multiple input-multiple output (MIMO) and carrier aggregation communication configurations.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting a request message including a request to adjust one or more parameters associated with a multiple input-multiple output (MIMO) configuration, a carrier aggregation configuration, or both in accordance with one or more triggering parameters satisfying a threshold, receiving a response message, where the response message indicates for the UE to adjust the one or more parameters in accordance with the request message, and performing wireless communications in accordance with one or more adjusted parameters.

A UE for wireless communications is described. The UE may include one or more memories storing processor executable code, and one or more processors coupled with the one or more memories. The one or more processors may individually or collectively be operable to execute the code to cause the UE to transmit a request message including a request to adjust one or more parameters associated with a MIMO configuration, a carrier aggregation configuration, or both in accordance with one or more triggering parameters satisfying a threshold, receive a response message, where the response message indicates for the UE to adjust the one or more parameters in accordance with the request message, and perform wireless communications in accordance with one or more adjusted parameters.

Another UE for wireless communications is described. The UE may include means for transmitting a request message including a request to adjust one or more parameters associated with a MIMO configuration, a carrier aggregation configuration, or both in accordance with one or more triggering parameters satisfying a threshold, means for receiving a response message, where the response message indicates for the UE to adjust the one or more parameters in accordance with the request message, and means for performing wireless communications in accordance with one or more adjusted parameters.

A non-transitory computer-readable medium storing code for wireless communications is described. The code may include instructions executable by one or more processors to transmit a request message including a request to adjust one or more parameters associated with a MIMO configuration, a carrier aggregation configuration, or both in accordance with one or more triggering parameters satisfying a threshold, receive a response message, where the response message indicates for the UE to adjust the one or more parameters in accordance with the request message, and perform wireless communications in accordance with one or more adjusted parameters.

Some examples of the method, UEs, and non-transitory computer-readable medium described herein may further include operations, features, means, or instructions for adjusting the one or more parameters to the one or more adjusted parameters in accordance with receiving the response message, where performing the wireless communications may be in accordance with adjusting the one or more parameters.

Some examples of the method, UEs, and non-transitory computer-readable medium described herein may further include operations, features, means, or instructions for tracking a set of multiple triggering parameters at the UE, where the set of multiple triggering parameters includes the one or more triggering parameters and transmitting the request message may be in accordance with the one or more triggering parameters of the set of multiple triggering parameters satisfying the threshold.

In some examples of the method, UEs, and non-transitory computer-readable medium described herein, the set of multiple triggering parameters include an uplink data rate, one or more latency thresholds, one or more channel conditions at the UE, power consumption at the UE, one or more application-based data rates, one or more application-based latency thresholds, a position of the UE, or any combination thereof and the one or more channel conditions include an uplink transmission power, a channel path loss, a modulation and coding scheme (MCS) allocation, a resource block allocation, or any combination thereof.

In some examples of the method, UEs, and non-transitory computer-readable medium described herein, tracking the set of multiple triggering parameters at the UE may include operations, features, means, or instructions for inputting one or more detected triggering parameter values associated with the set of multiple triggering parameters into a machine learning (ML) model, where an output of the ML model corresponds to the one or more parameters.

In some examples of the method, UEs, and non-transitory computer-readable medium described herein, the one or more parameters include a quantity of transmit chains, a quantity of secondary downlink carriers, a quantity of secondary uplink carriers, activation or deactivation of one or more secondary downlink carriers of the secondary downlink carriers, activation or deactivation of one or more secondary uplink carriers of the secondary uplink carriers, activation or deactivation of one or more supplementary uplink (SUL) carriers, or any combination thereof.

In some examples of the method, UEs, and non-transitory computer-readable medium described herein, the request message may be transmitted via uplink control information (UCI) or a medium access control-control element (MAC-CE).

In some examples of the method, UEs, and non-transitory computer-readable medium described herein, the response message may be received via downlink control information (DCI) or a MAC-CE.

In some examples of the method, UEs, and non-transitory computer-readable medium described herein, the request to adjust the one or more parameters include a request to adjust at least one first parameter associated with the MIMO configuration and to adjust at least one second parameter associated with the carrier aggregation configuration and the one or more parameters includes the at least one first parameter and the at least one second parameter.

A method for wireless communications by a network entity is described. The method may include obtaining a request message including a request to adjust one or more parameters associated with a MIMO configuration, a carrier aggregation configuration, or both, where obtaining the request message is in accordance with one or more capabilities of a UE, outputting a response message in response to the request, where the response message indicates for the UE to adjust the one or more parameters in accordance with the request, and performing wireless communications in accordance with one or more adjusted parameters.

A network entity for wireless communications is described. The network entity may include one or more memories storing processor executable code, and one or more processors coupled with the one or more memories. The one or more processors may individually or collectively be operable to execute the code to cause the network entity to obtain a request message including a request to adjust one or more parameters associated with a MIMO configuration, a carrier aggregation configuration, or both, where obtaining the request message is in accordance with one or more capabilities of a UE, output a response message in response to the request, where the response message indicates for the UE to adjust the one or more parameters in accordance with the request, and perform wireless communications in accordance with one or more adjusted parameters.

Another network entity for wireless communications is described. The network entity may include means for obtaining a request message including a request to adjust one or more parameters associated with a MIMO configuration, a carrier aggregation configuration, or both, where obtaining the request message is in accordance with one or more capabilities of a UE, means for outputting a response message in response to the request, where the response message indicates for the UE to adjust the one or more parameters in accordance with the request, and means for performing wireless communications in accordance with one or more adjusted parameters.

A non-transitory computer-readable medium storing code for wireless communications is described. The code may include instructions executable by one or more processors to obtain a request message including a request to adjust one or more parameters associated with a MIMO configuration, a carrier aggregation configuration, or both, where obtaining the request message is in accordance with one or more capabilities of a UE, output a response message in response to the request, where the response message indicates for the UE to adjust the one or more parameters in accordance with the request, and perform wireless communications in accordance with one or more adjusted parameters.

In some examples of the method, network entities, and non-transitory computer-readable medium described herein, the one or more parameters include a quantity of transmit chains, a quantity of secondary downlink carriers, a quantity of secondary uplink carriers, activation or deactivation of one or more secondary downlink carriers of the secondary downlink carriers, activation or deactivation of one or more secondary uplink carriers of the secondary uplink carriers, activation or deactivation of one or more SUL carriers, or any combination thereof.

In some examples of the method, network entities, and non-transitory computer-readable medium described herein, the request message may be obtained via UCI, a MAC-CE message, or any combination thereof.

In some examples of the method, network entities, and non-transitory computer-readable medium described herein, the response message may be output via DCI, a MAC-CE message, or any combination thereof.

In some examples of the method, network entities, and non-transitory computer-readable medium described herein, the one or more parameters includes the at least one first parameter and the at least one second parameter.

A method for wireless communications by a UE is described. The method may include receiving a first control message indicating one or more timers associated with one or more parameters, the one or more parameters associated with a MIMO configuration, a carrier aggregation configuration, or both, initiating, in accordance with receiving the first control message, a first timer of the one or more timers in accordance with one or more triggering parameters satisfying a threshold, and adjusting the one or more parameters in accordance with expiry of the first timer.

A UE for wireless communications is described. The UE may include one or more memories storing processor executable code, and one or more processors coupled with the one or more memories. The one or more processors may individually or collectively be operable to execute the code to cause the UE to receive a first control message indicating one or more timers associated with one or more parameters, the one or more parameters associated with a MIMO configuration, a carrier aggregation configuration, or both, initiate, in accordance with receiving the first control message, a first timer of the one or more timers in accordance with one or more triggering parameters satisfying a threshold, and adjust the one or more parameters in accordance with expiry of the first timer.

Another UE for wireless communications is described. The UE may include means for receiving a first control message indicating one or more timers associated with one or more parameters, the one or more parameters associated with a MIMO configuration, a carrier aggregation configuration, or both, means for initiating, in accordance with receiving the first control message, a first timer of the one or more timers in accordance with one or more triggering parameters satisfying a threshold, and means for adjusting the one or more parameters in accordance with expiry of the first timer.

A non-transitory computer-readable medium storing code for wireless communications is described. The code may include instructions executable by one or more processors to receive a first control message indicating one or more timers associated with one or more parameters, the one or more parameters associated with a MIMO configuration, a carrier aggregation configuration, or both, initiate, in accordance with receiving the first control message, a first timer of the one or more timers in accordance with one or more triggering parameters satisfying a threshold, and adjust the one or more parameters in accordance with expiry of the first timer.

Some examples of the method, UEs, and non-transitory computer-readable medium described herein may further include operations, features, means, or instructions for tracking the one or more triggering parameters at the UE, where the one or more triggering parameters include an uplink data rate, one or more latency thresholds, one or more channel conditions at the UE, power consumption at the UE, one or more application-based data rates, one or more application-based latency thresholds, a position of the UE, or any combination thereof, where the one or more channel conditions include an uplink transmission power, a channel path loss, a MCS allocation, a resource block allocation, or any combination thereof.

In some examples of the method, UEs, and non-transitory computer-readable medium described herein, tracking the one or more triggering parameters at the UE may include operations, features, means, or instructions for inputting one or more detected triggering parameter values associated with the one or more triggering parameters into a ML model, where an output of the ML model corresponds to the one or more parameters.

Some examples of the method, UEs, and non-transitory computer-readable medium described herein may further include operations, features, means, or instructions for transmitting a request message, via UCI or via a MAC-CE, including a request to increase the one or more parameters and receiving a response message, via DCI or via a second MAC-CE, in response to the request, where the response message indicates for the UE to increase the one or more parameters in accordance with the request message.

In some examples of the method, UEs, and non-transitory computer-readable medium described herein, adjusting the one or more parameters may include operations, features, means, or instructions for decreasing a quantity of transmit chains, decreasing a quantity of secondary carriers, deactivation of one or more secondary carriers, or any combination thereof in accordance with the expiry of the first timer, where the secondary carriers include one or more secondary downlink carriers, one or more secondary uplink carriers, or any combination thereof.

In some examples of the method, UEs, and non-transitory computer-readable medium described herein, the one or more parameters may include one or more secondary carriers and adjusting the one or more parameters may include operations, features, means, or instructions for receiving, via the first control message or a second message, an indication of a set of multiple priority levels associated with the one or more secondary carriers, where the one or more secondary carriers include one or more secondary uplink carriers, one or more secondary downlink carriers, or any combination thereof and deactivating at least one secondary carrier of the one or more secondary carriers in accordance with the set of multiple priority levels and in accordance with the expiry of the first timer.

In some examples of the method, UEs, and non-transitory computer-readable medium described herein, the one or more parameters may include a quantity of transmit chains and adjusting the one or more parameters may include operations, features, means, or instructions for decreasing the quantity of transmit chains from a first quantity to a second quantity in accordance with the expiry of the first timer of the one or more timers, where the second quantity may be associated with the first timer and decreasing the quantity of transmit chains from the second quantity to a third quantity in accordance with expiry of a second timer of the one or more timers, where the third quantity may be associated with the second timer.

In some examples of the method, UEs, and non-transitory computer-readable medium described herein, the one or more parameters may include a quantity of transmit chains and adjusting the one or more parameters may include operations, features, means, or instructions for decreasing the quantity of transmit chains to a threshold quantity after expiry of the first timer and transitioning from a first MIMO configuration to a second MIMO configuration in accordance with decreasing the quantity of transmit chains to the threshold quantity.

Some examples of the method, UEs, and non-transitory computer-readable medium described herein may further include operations, features, means, or instructions for adjusting the one or more parameters in accordance with expiry of a second timer of the one or more timers, the second timer different from the first timer.

In some examples of the method, UEs, and non-transitory computer-readable medium described herein, the first control message includes a system information block (SIB), radio resource control (RRC) signaling, DCI, or any combination thereof.

A method for wireless communications by a network entity is described. The method may include outputting a first control message indicating one or more timers associated with one or more parameters, the one or more parameters associated with a MIMO configuration, a carrier aggregation configuration, or both, initiating, in accordance with receiving the first control message, a first timer of the one or more timers in accordance with one or more triggering parameters satisfying a threshold and in accordance with outputting the first control message, and performing wireless communications in accordance with initiating the first timer and the MIMO configuration, the carrier aggregation configuration, or both corresponding to the one or more parameters.

A network entity for wireless communications is described. The network entity may include one or more memories storing processor executable code, and one or more processors coupled with the one or more memories. The one or more processors may individually or collectively be operable to execute the code to cause the network entity to output a first control message indicating one or more timers associated with one or more parameters, the one or more parameters associated with a MIMO configuration, a carrier aggregation configuration, or both, initiate, in accordance with receiving the first control message, a first timer of the one or more timers in accordance with one or more triggering parameters satisfying a threshold and in accordance with outputting the first control message, and perform wireless communications in accordance with initiating the first timer and the MIMO configuration, the carrier aggregation configuration, or both corresponding to the one or more parameters.

Another network entity for wireless communications is described. The network entity may include means for outputting a first control message indicating one or more timers associated with one or more parameters, the one or more parameters associated with a MIMO configuration, a carrier aggregation configuration, or both, means for initiating, in accordance with receiving the first control message, a first timer of the one or more timers in accordance with one or more triggering parameters satisfying a threshold and in accordance with outputting the first control message, and means for performing wireless communications in accordance with initiating the first timer and the MIMO configuration, the carrier aggregation configuration, or both corresponding to the one or more parameters.

A non-transitory computer-readable medium storing code for wireless communications is described. The code may include instructions executable by one or more processors to output a first control message indicating one or more timers associated with one or more parameters, the one or more parameters associated with a MIMO configuration, a carrier aggregation configuration, or both, initiate, in accordance with receiving the first control message, a first timer of the one or more timers in accordance with one or more triggering parameters satisfying a threshold and in accordance with outputting the first control message, and perform wireless communications in accordance with initiating the first timer and the MIMO configuration, the carrier aggregation configuration, or both corresponding to the one or more parameters.

Some examples of the method, network entities, and non-transitory computer-readable medium described herein, where the one or more parameters may include one or more secondary carriers, may further include operations, features, means, or instructions for outputting, via the first control message or a second message, an indication of a set of multiple priority levels associated with one or more secondary carriers, where the one or more secondary carriers include one or more secondary uplink carriers, one or more secondary downlink carriers, or any combination thereof.

Some examples of the method, network entities, and non-transitory computer-readable medium described herein may further include operations, features, means, or instructions for obtaining a request message, via UCI or via a MAC-CE, including a request to increase the one or more parameters at a UE and outputting a message, via DCI or via a second MAC-CE, in response to the request, where the message indicates for the UE to increase the one or more parameters in accordance with obtaining the request message.

In some examples of the method, network entities, and non-transitory computer-readable medium described herein, the one or more parameters include a quantity of transmit chains, a quantity of secondary downlink carriers, a quantity of secondary uplink carriers, an activation or deactivation of one or more secondary downlink carriers, an activation or deactivation of one or more secondary uplink carriers, or any combination thereof.

In some examples of the method, network entities, and non-transitory computer-readable medium described herein, the first control message may be transmitted via a SIB, RRC signaling, DCI, or any combination thereof.

Some examples of the method, network entities, and non-transitory computer-readable medium described herein may further include operations, features, means, or instructions for outputting the first control message may be in accordance with one or more capabilities of a UE.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1-3 show examples of wireless communications systems that support dynamic multiple input-multiple output (MIMO) and carrier aggregation communication configurations in accordance with one or more aspects of the present disclosure.

FIGS. 4A, 4B, 5, and 6 show examples of transition procedures that support dynamic MIMO and carrier aggregation communication configurations in accordance with one or more aspects of the present disclosure.

FIGS. 7 and 8 show examples of process flows that support dynamic MIMO and carrier aggregation communication configurations in accordance with one or more aspects of the present disclosure.

FIGS. 9 and 10 show block diagrams of devices that support dynamic MIMO and carrier aggregation communication configurations in accordance with one or more aspects of the present disclosure.

FIG. 11 shows a block diagram of a communications manager that supports dynamic MIMO and carrier aggregation communication configurations in accordance with one or more aspects of the present disclosure.

FIG. 12 shows a diagram of a system including a device that supports dynamic MIMO and carrier aggregation communication configurations in accordance with one or more aspects of the present disclosure.

FIGS. 13 and 14 show block diagrams of devices that support dynamic MIMO and carrier aggregation communication configurations in accordance with one or more aspects of the present disclosure.

FIG. 15 shows a block diagram of a communications manager that supports dynamic MIMO and carrier aggregation communication configurations in accordance with one or more aspects of the present disclosure.

FIG. 16 shows a diagram of a system including a device that supports dynamic MIMO and carrier aggregation communication configurations in accordance with one or more aspects of the present disclosure.

FIGS. 17 through 20 show flowcharts illustrating methods that support dynamic MIMO and carrier aggregation communication configurations in accordance with one or more aspects of the present disclosure.

### DETAILED DESCRIPTION

In some wireless communications systems, a user equipment (UE) may support multiple input-multiple output (MIMO) configurations or carrier aggregation configurations for communication. The configurations may be configured or reconfigured by control signaling (e.g., radio resource control (RRC) signaling) from a network entity. In some cases, the UE may experience or may be configured to perform periodic or aperiodic signaling (e.g., bursty data traffic), which may result in dynamic changes to data transfer parameters (e.g., triggering parameters) at the UE. For example, the UE may perform a large amount of uplink signaling, or receive a large among of downlink signaling during a brief period of time, but may perform relatively small amounts of signaling (e.g., or may experience no data traffic) during other time periods. However, a MIMO or carrier aggregation communication configuration at the UE may be static or semi-static. That is, the network entity and the UE may not support dynamic changes to MIMO or carrier aggregation communication configurations. Further, in some cases, the UE may be capable of tracking and measuring on or more triggering parameters (e.g., data rate, channel conditions, latency thresholds, a position of the UE, or any combination thereof). That is, the UE may, based on tracking and measuring the triggering parameters, be capable of determining one or more changes or adjustments to the MIMO or carrier aggregation communication configuration, but may not be capable of reporting or requesting changes to the network entity.

For example, the UE may maintain transmit chains for uplink data transmissions, but in some cases, the UE may have more downlink data than uplink data and may maintain unutilized uplink transmit chains even when the UE may not have uplink data to transmit, leading to higher power consumption and unutilized computational resources, among other disadvantages. Additionally, or alternatively, the UE may have uplink data to transmit and may be able to transmit it more efficiently or reliably over more transmit chains than are currently configured. In some implementations, a UE may support downlink carrier aggregation, uplink carrier aggregation, or both configured and may support one or more secondary carriers that are activated. However, there may be more secondary carriers activated than necessary at the UE, leading to increased power consumption and other disadvantages, or it may be beneficial to activate more secondary carriers in order to support higher data rates, among other advantages. In some implementations, a UE may be configured for supplemental uplink (SUL) carriers, which may support UE uplink transmissions if the UE is located far from a network entity. However, the UE may not have uplink data to transmit on a SUL carrier or may be located close to the network entity. In these cases, it may be beneficial to deactivate the SUL carrier until the UE may have uplink data to transmit, or until the UE may change position to a location farther from the network entity. However, control signaling from the network entity may not support UE reports or requests for reconfiguration, or may not be efficient or dynamic enough to support changes to the MIMO or carrier aggregation communication configurations. If the wireless communications system does not support any mechanism by which the UE can report or request adjustments to MIMO or carrier aggregation configurations, or if such adjustments are not available to the UE, then the UE may experience increased power expenditures, decreased battery life, inefficient use of available system resources, less efficient use of available computational resources, poor coordination between devices, and decreased user experience.

The techniques described herein support a UE dynamically requesting to adjust one or more parameters associated with the MIMO or carrier aggregation communication configurations, implicitly changing the one or more parameters based on one or more timers, or a combination thereof. In some implementations, a UE may track triggering parameters related to various conditions at the UE. If one or more of the triggering parameters satisfy a threshold, the UE may be triggered to transmit a request message. The request message, which the UE may transmit to a network entity via uplink control information (UCI) or medium access control-control element (MAC-CE), may request to adjust one or more parameters, which may include a quantity of transmit chains, a quantity of secondary carriers, a quantity of active secondary carriers, a quantity of active SUL carriers, or any combination thereof. In some cases, transmitting the request may be based on some capabilities at the UE, such as artificial intelligence (AI) or machine learning (ML) capabilities to track and evaluate the triggering parameters. In response to the request message, the network entity may transmit, via downlink control information (DCI) or MAC-CE, a response to the UE indicating to adjust the one or more parameters.

In some implementations, the UE may adjust (e.g., decrease or deactivate) one or more parameters associated with the MIMO or carrier aggregation configurations based on one or more timers. For example, the network entity may indicate, to the UE, one or more timers associated with adjusting one or more parameters. The UE may initiate the timers (e.g., based on tracking the triggering conditions), and may, based on expiry of a timer, adjust the one or more parameters. For example, the UE may not transmit any uplink data within a timer and may, based on expiry of the timer, decrease or deactivate one or more of the parameters. In some examples, the UE may generate uplink data for transmission and may transmit a request to increase or activate the one or more parameters that may have been adjusted based on the timers. In some examples, initiating the timers, transmitting the request, or both may be based on the tracking performed by the UE, which may be associated with the capabilities of the UE, such as AI or ML capabilities.

Aspects of the disclosure are initially described in the context of wireless communications systems and transition procedures. Aspects of the disclosure are further illustrated by and described with reference to apparatus diagrams, system diagrams, and flowcharts that relate to dynamic MIMO and carrier aggregation communication configurations.

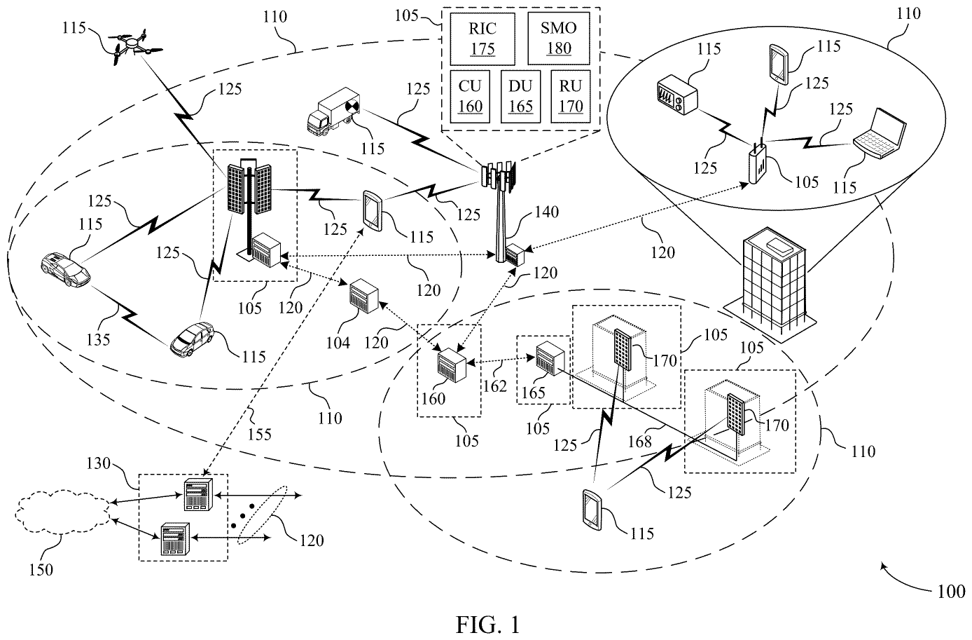

FIG. 1 shows an example of a wireless communications system 100 that supports dynamic MIMO and carrier aggregation communication configurations in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support dynamic MIMO and carrier aggregation communication configurations as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating according to lower power (e.g., a base station 140 operating according to lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some wireless communications systems 100, a UE 115 may support MIMO or carrier aggregation communication that may be configured or reconfigured by control signaling (e.g., RRC signaling) from a network entity 105. In some cases, the UE 115 may experience or may be configured for bursty data traffic, which may result in dynamic changes to data transfer parameters (e.g., triggering parameters) at the UE 115. However, a MIMO or carrier aggregation communication configuration at the UE 115 may be static or semi-static. That is, the network entity 105 and the UE 115 may not support dynamic MIMO or carrier aggregation communication configuration. Further, in some cases, the UE 115 may be capable of tracking and measuring the triggering parameters (e.g., data rate, channel conditions, latency thresholds, a position of the UE 115, or any combination thereof). That is, the UE 115 may, based on tracking and measuring the triggering parameters, be capable of determining one or more changes or adjustments to the MIMO or carrier aggregation communication configuration, but may not support signaling to report or request changes to the network entity 105.

For example, the UE 115 may maintain transmit chains for uplink data, but in some cases, the UE 115 may have more downlink data than uplink data and may maintain uplink transmit chains even when the UE 115 may not have uplink data to transmit, leading to higher power consumption, among other disadvantages. Additionally, or alternatively, the UE 115 may have uplink data to transmit and may be able to transmit it more efficiently or reliably over more transmit chains than may be configured. In some implementations, a UE 115 may support downlink carrier aggregation, uplink carrier aggregation, or both configured and may support one or more secondary carriers that are activated. However, there may be more secondary carriers activated than necessary at the UE 115, leading to increased power consumption and other disadvantages, or it may be beneficial to activate more secondary carriers in order to support higher data rates, among other advantages. In some implementations, a UE 115 may be configured for supplemental uplink (SUL) carriers, which may support UE 115 uplink transmissions if the UE 115 is located far from a network entity. However, the UE 115 may not have uplink data to transmit on a SUL carrier or may be located close to the network entity 105. In these cases, it may be beneficial to deactivate the SUL carrier until the UE 115 may have uplink data to transmit, or until the UE 115 may change position to a location farther from the network entity 105. However, control signaling from the network entity 105 may not support UE 115 reports or requests for reconfiguration, or may not be efficient or dynamic enough to support changes to the MIMO or carrier aggregation communication configurations. If the wireless communications system 100 does not support any mechanism by which the UE 115 can report or request adjustments to MIMO configurations, carrier aggregation configurations, or both, or if such adjustments are not available to the UE 115, then the UE 115 may experience increased power expenditures, decreased battery life, inefficient use of available system resources, less efficient use of available computational resources, poor coordination between devices, and decreased user experience.

In some wireless communications systems 100, a UE 115 may dynamically request to adjust one or more parameters associated with the MIMO or carrier aggregation communication configurations, implicitly changing the one or more parameters based on one or more timers, or a combination thereof. In some implementations, the UE 115 may track triggering parameters related to various conditions at the UE 115. If one or more of the triggering parameters satisfy a threshold, the UE 115 may be triggered to transmit a request message. The request message, which the UE 115 may transmit to a network entity 105 via UCI or MAC-CE, may request to adjust one or more parameters, which may include a quantity of transmit chains, a quantity of secondary carriers, a quantity of active secondary carriers, a quantity of active SUL carriers, or any combination thereof. In some cases, transmitting the request may be based on some capabilities at the UE 115, such as AI or ML capabilities to track and evaluate the triggering parameters. In response to the request message, the network entity 105 may transmit, via DCI or MAC-CE, a response to the UE 115 indicating to adjust the one or more parameters.

In some implementations, the UE 115 may adjust (e.g., decrease or deactivate) one or more parameters associated with the MIMO or carrier aggregation configurations based on one or more timers. For example, the network entity 105 may indicate, to the UE 115, one or more timers associated with adjusting one or more parameters. The UE 115 may initiate the timers (e.g., based on tracking the triggering conditions), and may, based on expiry of a timer, adjust the one or more parameters. For example, the UE 115 may not transmit any uplink data within a timer and may, based on expiry of the timer, decrease or deactivate one or more of the parameters. In some examples, the UE 115 may generate uplink data for transmission and may transmit a request to increase or activate the one or more parameters that may have been adjusted based on the timers. In some examples, initiating the timers, transmitting the request, or both may be based on the tracking performed by the UE 115, which may be associated with the capabilities of the UE 115, such as AI or ML capabilities.

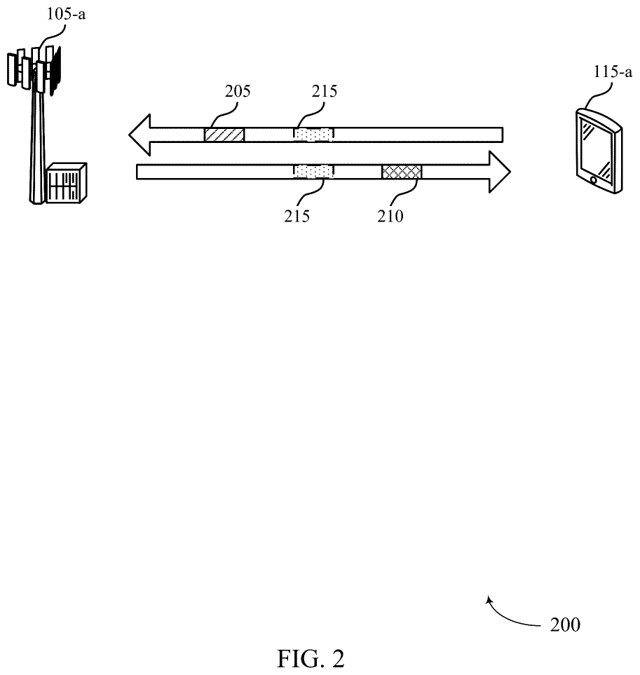

FIG. 2 shows an example of a wireless communications system 200 that supports dynamic MIMO and carrier aggregation communication configurations in accordance with one or more aspects of the present disclosure. For example, the wireless communications system 200 may include a UE 115-a and a network entity 105-a, which may be examples of the corresponding devices as described herein, including with reference to FIG. 1. The techniques described in the context of the wireless communications system 200 may enable the UE 115-a to request to adjust parameters associated with the MIMO configurations, carrier aggregation communication configurations, or both.

In some wireless communications systems 200, a UE 115-a may perform transmission or receptions in a periodic or aperiodic manner (e.g., may be configured for bursty data transmissions). That is, the UE 115-a, au experience burst data requirements where the UE 115-a has a high data transfer requirement for a small duration and may have low or no data transfer otherwise (e.g., high data transfer requirements and low or no data transfer requirements). In some cases, the UE 115-a may experience more or higher downlink data signaling, such as from the network entity 105-a, and may have less or lower uplink data signaling in comparison. Accordingly, a relatively static MIMO configuration, carrier aggregation configuration, or both that may not balance communication quality and power consumption at the UE 115-a, because use cases for the UE 115-a may change dynamically (e.g., often). For example, a preferred uplink MIMO configuration, quantity of transmit chains, downlink carrier aggregation configuration, uplink carrier aggregation configuration, a SUL carrier aggregation configuration, or any combination thereof may dynamically change based on conditions at the UE 115-a (e.g., the conditions may change more dynamically than the MIMO configuration, the CA configuration, or both).

In some implementations, a UE 115-a may support multiple uplink layers, associated with transmit chains, for wireless communications. For example, an uplink MIMO configuration may support two layers, four layers, or more. In some cases, such as time division duplexing deployments, a UE 115-a may be configured with a two layer uplink MIMO configuration. However, the UE 115-a may not have uplink data to transmit, such as in the case where the UE 115-a may be receiving more downlink data than uplink data. In some implementations, the UE 115-a may configure and maintain the uplink layers and associated transmit chains for longer durations, even with no uplink data to transmit, based on the greater amount of downlink data scheduled, which may lead to a higher power consumption (e.g., due to unnecessarily maintaining uplink uplink transmit chains or supporting multiple uplink MIMIO layers).

In some cases, the UE 115-a may transmit user assisted information (UAI) via RRC signaling. In some examples, the UAI may indicate, to the network entity 105-a, a maximum or threshold quantity of transmit chains that the UE 115-a may support. The UAI may not indicate a requested (e.g., desired) uplink configuration, such as an uplink MIMO configuration or quantity of transmit chains. That is, the UAI may not allow for dynamic reporting or requests from the UE. Further, transmitting the UAI may be associated with increased RRC signal processing overhead at the network entity 105-a. Instead, the UE 115-a may use lower layer (e.g., medium access control (MAC) or physical (PHY) layer) signaling to dynamically report and request changes to the uplink MIMO configuration and the quantity of transmit chains.

In some implementations, the UE 115-a may track triggering parameters associated with a data transfer. In some examples, the network entity 105-a may not track UE-specific parameters associated with the data transfer. That is, the network entity 105-a may track generic data usage and may not track UE-specific parameters. However, the UE 115-a may track specific triggering parameters at the UE 115-a, which may allow the UE 115-a to determine a quantity of transmit chains or an uplink MIMO configuration. The triggering parameters may include an uplink data rate, latency thresholds (e.g., requirements), application-specific parameters, channel conditions at the UE 115-a, or any combination hereof, wherein the channel conditions may include requested transmission power, path loss related the position of UE 115-a within a cell (e.g., near, mid, or far cell), allocated resource blocks, an allocated modulation and coding scheme (MCS), or any combination thereof. In some examples, the UE 115-a may track data transfer and latency thresholds associated with specific applications (e.g., gaming, video calling, video streaming, audio streaming, audio calling, other such examples, or any combination thereof). In some cases, the UE 115-a may implement machine learning (ML) models, artificial intelligence (AI) models, or any combination thereof, to track the triggering parameters, such as the data and latency thresholds associated with applications and channel conditions. That is, the UE 115-a may input measurements related to the one or more triggering parameters into the ML or AI models and the output may trigger a request to change or adjust the quantity of transmit chains, the uplink MIMO configuration, activation or deactivation of carriers, etc..

The UE 115-a may, if the triggering parameters satisfy one or more thresholds, based on the output of the ML or AI model, or any combination thereof, transmit a request message 205 to the network entity 105-a. The request message 205 may dynamically request a quantity of transmit chains, a specific uplink MIMO configuration, a carrier aggregation configuration, or any combination thereof. In some cases, the request message 205 may be transmitted via physical uplink control channel (PUCCH) or physical uplink shared channel (PUSCH) as UCI. In some cases, the request message 205 may be transmitted as a MAC-CE. Enabling the UE 115-a to transmit the request message 205 may improve the utilization of resources at the network entity 105-a and reduce power consumption at the UE 115-a.

In some examples, the UE 115-a may use a quantity of bits, such as three bits (e.g., 0, 1 . . . 7) to indicate the requested quantity of transmit chains (e.g., uplink chains) and a quantity of bits, such as three bits (e.g., 0, 1 . . . 7 Enum)) to indicate the requested uplink MIMO configuration. For example, the UE 115-a may measure or track the one or more triggering parameters to determine an uplink configuration. In a first example, a UE 115-a may maintain a high data rate threshold and may be in the near cell, which may be associated with good channel conditions, or low path loss. In this example, the UE 115-a may request to enable uplink MIMO with spatial multiplexing with dual layer (SMDL). The UE 115-a may transmit the request message 205 with specific bits to indicate a two layer uplink MIMO configuration with SMDL, such as 010 011. For example, the most significant bits (e.g., the first three bits) may be associated with the requested quantity of transmit chains and the least significant bits (e.g., the second three bits) may be associated with the requested uplink MIMO configuration. In a second example, the UE 115-a may have medium or low data thresholds and may be in mid-cell, associated with medium channel conditions or a medium path loss. The UE 115-a may utilize algorithms or other methods to determine which uplink MIMO configuration to enable (e.g., MIMO, single input-single output (SISO), transmission diversity) based on the triggering parameters, such as channel conditions (e.g., transmission power, allocated resources blocks, allocated MCS). In a third example, the UE 115-a may have medium or low data thresholds and may be in the far cell, associated with bad channel conditions and a high path loss. The UE 115-a may request to enable uplink MIMO with transmission diversity through spatial multiplexing with single layer (SMSL). The UE 115-a may transmit the request message 205 with specific bits to indicate a two layer uplink MIMO communication configuration with SMSL, such as 010 001.

The network entity 105-a may output a response message 210 in response to obtaining the request message 205 from the UE 115-a. The response message 210 may indicate (e.g., command) for the UE 115-a to adjust the quantity of transmit chains, the uplink MIMO configuration, a carrier aggregation configuration, or any combination thereof, in accordance with the request message 205. In some cases, the response message 210 may be transmitted via PDCCH as DCI. In some cases, the request message 205 may be transmitted as a MAC-CE. In some cases, the response message 210 may implement a similar scheme using bits as described above to indicate the uplink MIMO configuration and the quantity of transmit chains as described with reference to the request message 205. The UE 115-a may adjust or change the quantity of transmit chains, the uplink MIMO configuration, the carrier aggregation configuration, or any combination thereof in accordance with the response message 210, and the network entity 105-a and the UE 115-a may perform wireless communications 215 based on the adjustments.

In some implementations, the UE 115-a may support downlink carrier aggregation, which may enable the network entity 105-a to simultaneously transmit data on multiple downlink carriers, increasing a downlink data rate. In some cases, such as during bursty traffic, the network entity 105-a may have little to no data to transmit to the UE 115-a. In some examples, the network entity 105-a may deactivate secondary downlink carriers at the UE 115-a, and may deactivate the secondary downlink carriers when the network entity 105-a may have data to transmit (e.g., the downlink data rate increases). However, deactivating and activating the secondary downlink carriers may be associated with a long delay or timeline gap. Thus, the UE 115-a may maintain secondary downlink carriers and may continuously decode physical downlink control channels (PDCCHs) at each slot on the activated carriers. This may increase power consumption at the UE 115-a. For example, a modem associated with the UE 115-a may configure higher voltage and clocks at the UE 115-a to support decoding the expected data on each downlink carrier, even in case where there is no data scheduled on the activated secondary downlink carriers, or any of the downlink carriers. In some examples, the UE 115-a may enable radio frequency (RF) paths for each activated carrier, and may use RF circuitry to decode each activated downlink carrier, even when there is no data on the activated secondary downlink carriers. The modem configuration and use of RF circuitry at the UE 115-a may be associated with much higher power usage, as the modem configuration may be associated with a large portion (e.g., about 25%) of the power consumption at UE 115-a and the RF circuitry may be associated with a large portion (e.g., about 40%) of the power consumption at the UE 115-a.

In some cases, the UE 115-a may transmit the UAI via RRC signaling, which may indicate, to the network entity 105-a, a maximum or threshold quantity of downlink carrier configurations, but may not indicate information about the activation or deactivation of secondary downlink carriers. That is, the UAI may not support dynamic reporting or requesting of downlink carrier aggregation configuration changes or adjustments. Further, transmitting UAI via RRC signaling to indicate information about the downlink carrier aggregation configuration may be associated with high RRC signal processing overhead. Instead, the UE 115-a may use lower layer (e.g., medium access control (MAC) or physical (PHY) layer) signaling to dynamically report and request changes to the downlink carrier aggregation configuration and a quantity of activated secondary downlink carriers.

In some cases, the UE 115-a may transmit the request message 205 that may request to adjust a downlink carrier aggregation configuration, such as by adjusting a quantity of secondary downlink carriers, or a quantity of activated secondary downlink carriers, based on the conditions at the UE, such as the downlink data rate and latency thresholds. The UE 115-a may transmit the request message 205 via UCI or MAC-CE. In some examples, the UE 115-a may request to deactivate one or more secondary downlink carriers based on a downlink data threshold at the UE 115-a. The UE 115-a may indicate which specific secondary downlink carriers to deactivate or activate using bits in the request message 205. For example, to deactivate a second secondary downlink carrier, the UE 115-a may inform the network entity 105-a in the request message 205 using a code point (e.g., bits 010). Based on a quantity of configured carriers, such as a maximum quantity of configured carriers, the quantity of bits may change to reflect the quantity of configured carriers. In some cases, the UE 115-a may implement algorithms, such as AI or ML models, to track data and latency thresholds of applications and may, based on the tracking, request the network entity 105-a to configure or register a quantity of secondary carriers, activate specific secondary carriers, or both.

The network entity 105-a may transmit the response message 210 in response to the request message 205. The response message may indicate for the UE 115-a to adjust the downlink carrier aggregation configuration as indicated in the request message. In some cases, the network entity 105-a may balance a load at the network entity 105-a and the requested adjustments from the UE 115-a to determine the changes to the downlink carrier aggregation configuration. The network entity 105-a may send response message 210 via DCI or MAC-CE. The network entity 105-a may deactivate or adjust the secondary downlink carriers for multiple different UEs 115, including the UE 115-a, which may help balance the load at the network entity 105-a. In some cases, the network entity 105-a may output a message to adjust parameters to the UE 115-a and other UEs 115 based on the load at the network entity 105-a. That is, in some cases, the network entity 105-a may use the dynamic DCI and MAC-CE signaling to adjust parameters at the UE 115-a, even without receiving a request message from the UE 115-a. A dynamic request and response system for the downlink carrier aggregation configuration may improve utilization of network resources and lower power consumption at the UE 115-a, among other advantages.

In some implementations, the UE 115-a may support uplink carrier aggregation, which may enable the UE 115-a to simultaneously transmit data on multiple uplink carriers, which may increase an uplink data rate. In some cases, such as during bursty traffic, the UE 115-a may have little to no data to transmit to the network entity 105-a. In some examples, the network entity 105-a may deactivate secondary uplink carriers at the UE 115-a, and may activate the secondary uplink carriers when the UE 115-a may have data to transmit (e.g., the uplink data rate increases). However, as with the secondary downlink carriers, deactivating and activating the secondary uplink carriers may be associated with a long delay or timeline gap. Thus, the UE 115-a may maintain secondary uplink carriers and associated transmit chains, which may increase power consumption at the UE 115-b. For example, the UE 115-a may continuously transmit sounding reference signals (SRS) on all activated uplink carriers with transmit chains configured, even if the UE 115-b may not transmit any uplink data on all the uplink carriers. Further, a modem associated with the UE 115-a may enable transmit paths for each activated carriers and may enable RF circuitry to transmit the SRS on each activated secondary uplink carrier, even when the UE 115-a may have no uplink data to transmit on the activated secondary uplink carriers. The modem may also configure higher voltage and clocks at the UE 115-a to support decoding expected data on each carrier, even in case where there is no data on the activated secondary uplink carriers.

The UE 115-a may transmit the UAI via RRC signaling, which may indicate, to the network entity 105-a, a maximum or threshold quantity of uplink carriers, but may not indicate information about the activation or deactivation of secondary uplink carriers. That is, the UAI may not support dynamic reporting or requesting of uplink carrier aggregation configuration changes or adjustments. Further, transmitting UAI via RRC signaling to indicate information about the uplink carrier aggregation configuration may be associated with high RRC signal processing overhead. Instead, the UE 115-a may use lower layer (e.g., medium access control (MAC) or physical (PHY) layer) signaling to dynamically report and request changes to the uplink carrier aggregation configuration and a quantity of secondary active carriers.

In some cases, the UE 115-a may transmit the request message 205 that may request to adjust the uplink carrier aggregation configuration, such as by adjusting a quantity of secondary uplink carriers, or a quantity of activated secondary uplink carriers, based on the conditions at the UE, such as the uplink data rate and latency thresholds. The UE 115-a may transmit the request message 205 via UCI or MAC-CE. In some examples, the UE 115-a may request to deactivate one or more secondary downlink carriers based on an uplink data threshold at the UE 115-a (e.g., no higher uplink data requirement). The UE 115-a may indicate to deactivate or activate specific secondary downlink carriers using bits in the request message 205. In some cases, the UE 115-a may implement algorithms, such as AI or ML models, to track data and latency thresholds of applications, as well as channel conditions at the UE 115-a (e.g., required uplink transmit power, channel path loss, MCS allocation, resource block allocation) and may, based on the tracking, request the network entity 105-a to configure or register a quantity of secondary uplink carriers, activate specific secondary uplink carriers, or both.

The network entity 105-a may transmit the response message 210 in response to the request message 205. The response message may indicate for the UE 115-a to adjust the uplink carrier aggregation configuration as indicated in the request message 205. In some cases, the network entity 105-a may balance a load at the network entity 105-a and the requested adjustments from the UE 115-a to determine the changes to the uplink carrier aggregation configuration. The network entity 105-a may send response message 210 via DCI or MAC-CE. The network entity 105-a may deactivate or adjust the secondary uplink carriers for multiple different UEs 115, including the UE 115-a, which may help balance the load at the network entity 105-a. In some cases, the network entity 105-a may output a message to adjust parameters to the UE 115-a and other UEs 115 based on the load at the network entity 105-a. That is, the network entity 105-a may use the dynamic DCI and MAC-CE signaling to adjust parameters at the UE 115-a, even without receiving a request message from the UE 115-a. A dynamic request and response system for the uplink carrier aggregation configuration may improve utilization of network resources and lower power consumption at the UE 115-a, among other advantages.

In some wireless communications systems 200, the UE 115-a may support a SUL configuration for massive MIMO (M-MIMO). Some wireless communications systems 300 may implement TDD frequency bands (e.g., FR1 TDD), which may be associated with M-MIMO. For example, the network entity 105-a may support TDD M-MIMO communication (e.g., via a TDD M-MIMO antenna), while some network entities 105 or antennas associated with the network entity 105-a may not support TDD M-MIMO, such as FDD passive antennas. M-MIMO systems may have high downlink equivalent isotropic radiated power (EIRP), but may have lower uplink EIRP. This may result in a link imbalance between the downlink and uplink, which may not be present with low band FDD carriers, such as the FDD passive antenna. SUL, as well as switched uplink, may extend the uplink range in high band or large bandwidth TDD uplink applications. To do this, the UE 115-a may use the uplink connection of the low band FDD carrier in addition to, or alternatively to, the TDD band. For example, near the network entity 105-a, the UE 115-a may use the TDD band in the downlink and may use one layer of a TDD band and one layer of an FDD band to support uplink communication. Further from the network entity 105-a, the UE 115-a may use the one layer FDD band to support uplink communication. Even further, the UE 115-a may use the FDD band for both downlink and uplink communication. That is, the SUL configuration may be dependent on the position of the UE 115-a within a cell, or the proximity of the UE 115-a to the network entity 105-a.

However, some wireless communications systems 200 may maintain a static or semi-static SUL configuration. That is, regardless of the data transfer thresholds (e.g., requirements) and the position of the UE 115-a with respect to the network entity 105-a, such as in the near cell, mid cell, or far cell, the SUL configuration may not change. For example, the UE 115-a may be near the network entity 105-a, such as in the near cell, and may not use a SUL carrier. However, the UE 115-a may maintain the SUL paths and may decode PDCCH on the SUL carriers even when there is no data, increasing power consumption. In some cases, the UE 115-a may consume higher power because the modem associated with the UE 115-a may configure higher voltages and clocks for transmitting data and receiving expected downlink data on the active carriers, including the active SUL carriers, even though there may be no data to transmit on the activated secondary carriers, including the SUL carriers. Further, the transmit paths and RF paths and RF circuitry, both to transmit and to receive and decode, may be maintained even if there is no uplink data.

In some cases, the UE 115-a may transmit the request message 205 which may request to adjust the SUL configuration, such as by adjusting a quantity of SUL carriers, a quantity of downlink carriers, a quantity of activated SUL carriers, a quantity of transmit chains, or any combination thereof based on the conditions at the UE 115-a, such as the uplink data rate and latency thresholds, as well as the position of the UE 115-a with respect to the network entity 105-a (e.g., within the coverage area of the primary carrier). The UE 115-a may transmit the request message 205 via UCI or MAC-CE. The UE 115-a may indicate to deactivate or activate SUL carriers using bits in the request message 205. In some cases, the UE 115-a may implement algorithms, such as AI or ML models, to track data and latency thresholds of applications, as well as channel conditions at the UE 115-a (e.g., near/mid/far cell, required uplink transmit power, channel path loss, MCS allocation, resource block allocation) and may, based on the tracking, request the network entity 105-a to configure or register a quantity of secondary uplink carriers, activate specific secondary uplink carriers, or both. For example, the UE may request, based on uplink data and latency thresholds, a quantity of uplink carriers, such as SUL carriers, a quantity of transmit chains, a MIMO configuration for a carrier (e.g., M-MIMO), or any combination thereof. In some examples, the UE may request, based on downlink data and latency thresholds, a quantity of downlink carriers associated with the SUL configuration.

The network entity 105-a may transmit the response message 210 in response to the request message 205. The response message may indicate for the UE 115-a to adjust the SUL configuration as indicated in the request message 205. In some cases, the network entity 105-a may balance a load at the network entity 105-a and the requested adjustments from the UE 115-a to determine the changes to the SUL configuration. The network entity 105-a may send response message 210 via DCI or MAC-CE. The network entity 105-a may deactivate or adjust the SUL carriers for multiple different UEs 115, including the UE 115-a, which may help balance the load at the network entity 105-a. A dynamic request and response system for the uplink carrier aggregation configuration may improve utilization of network resources and lower power consumption at the UE 115-a, among other advantages.

The request message 205 may include any of the aspects described herein. For example, the request message 205 may include a request to adjust a quantity of transit chains, an uplink MIMO configuration, a quantity of secondary downlink carriers, a quantity of secondary uplink carriers, a deactivation or activation of secondary downlink carriers, a deactivation or activation of secondary uplink carriers, a SUL configuration, a deactivation or activation of SUL carriers, or any combination thereof. That is, the request message 205 may adjust a MIMO configuration, a carrier aggregation configuration, or both. For example, the request message 205 may include a request, or multiple requests, to adjust parameters related to a MIMO configuration, parameters related to a carrier aggregation configuration, or both. That is, examples of the parameters may be MIMO parameters and carrier aggregation parameters, thus configuration may be adjusted separately for MIMO or carrier aggregation, or jointly for both MIMO or carrier aggregation, by a single or multiple requests. In some cases, the UE 115-a may send multiple request messages 205, such that each request message 205 corresponds to a MIMO configuration or a carrier aggregation configuration.

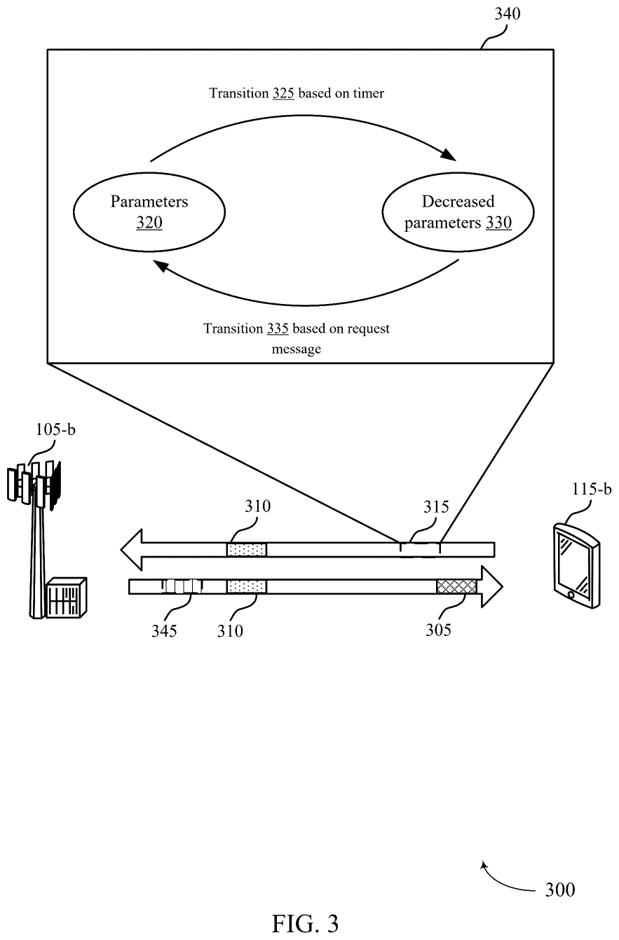

FIG. 3 shows an example of a wireless communications system 300 that supports dynamic MIMO and carrier aggregation communication configurations in accordance with one or more aspects of the present disclosure. For example, the wireless communications system 200 may include a UE 115-b and a network entity 105-b, which may be examples of the corresponding devices as described herein, including with reference to FIG. 1 and FIG. 2. The techniques described in the context of the wireless communications system 300 may enable the UE 115-b to adjust parameters associated with the MIMO and carrier aggregation configuration based on timers configured by the network entity 105-b.

In some wireless communications systems 300, as discussed further with respect to FIG. 2, a UE 115-b may be configured for bursty data. The UE 115-b may support multiple parameters, including uplink layers, transmit chains, and uplink MIMO configurations, as well as downlink carrier aggregation and uplink carrier aggregation configurations, as discussed further with reference to FIG. 2. Although the UE 115-b may indicate information about these parameters to the network entity 105-a via RRC signaling as UAI, as discussed with reference to FIG. 2, the UAI may not indicate specific changes or adjustments to the configurations and may be associated with high overhead, increased processing complexity, and high power consumption.

In some wireless communications systems 300, the network entity 105-b may transmit a control message 305 indicating timers associated with the multiple parameters. The UE 115-b may use the timers indicated in the control message 305 to determine when to change or adjust the associated parameters of the multiple parameters. For example, the UE 115-b may adjust the values of multiple parameters 320 after expiry of a related or respective timer (e.g., transition 325). In some implementations, the timers may indicate some duration with little or no data related to a parameter 320. After the duration reaches a threshold, or the timer expires, the UE 115-b may adjust (e.g., decrease a value of) the value of parameter 320 to reflect the little or no data for transmission, and thus save power. After decreasing the value of the parameters 320 based on the timer, the UE 115-b and the network entity 105-b may perform wireless communications 310 according to a MIMO configuration, carrier aggregation configuration, or both according to the decreased values of the parameters 330.

Initiating the timers or adjusting the value of the parameters may also be based on one or more triggering parameters satisfying one or more thresholds. In particular, the UE 115-a may track triggering parameters at the UE 115-a, which may allow the UE 115-a to determine changes or adjustments to current configurations which may improve latency, reduce power consumption, and improve communication quality and efficiency. The triggering parameters may include an uplink data rate, latency thresholds (e.g., requirements), application-specific parameters, channel conditions at the UE 115-a, or any combination hereof, wherein the channel conditions may include requested transmission power, path loss related the position of UE 115-a within a cell (e.g., near, mid, or far cell), allocated resource blocks, an allocated MCS, or any combination thereof. In some examples, the UE 115-a may track data transfer and latency thresholds associated with specific applications (e.g., gaming, video calling, video streaming, audio streaming, audio calling, other such examples, or any combination thereof). In some cases, the UE 115-a may implement machine learning (ML) models, artificial intelligence (AI) models, or any combination thereof, to track the triggering parameters, such as the data and latency thresholds associated with applications and channel conditions. That is, the UE 115-a may input measurements related to the one or more triggering parameters into the ML or AI models and the output may trigger a request to change or adjust the quantity of transmit chains, the uplink MIMO configuration, or both.

In some implementations, the UE 115-b may implement a transition procedure 340. For example, the UE may operate according to some parameters 320.

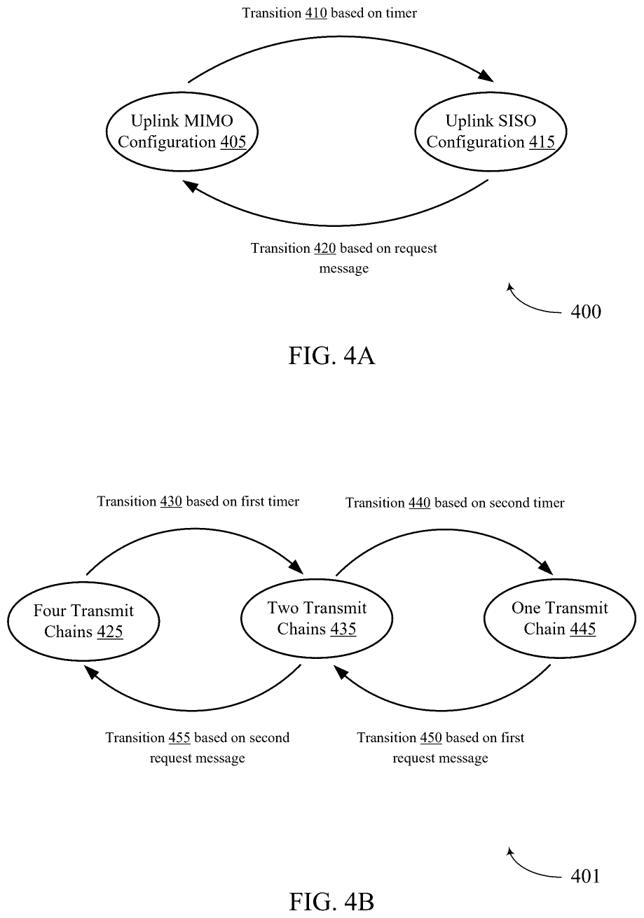

Based on expiry of a timer indicating a duration with little or no data related to the parameters, the UE 115-b may transition, at transition 325, to parameters 330 with decreased values. If the UE 115-b has data for transmission related to the parameters, the UE 115-b may perform transition 335 by transmitting request message 315 to the network entity 105-b, requesting to increase the values to the parameters 320. The network entity 105-b may respond with a response message 345 indicating for the UE 115-b to adjust the value of the parameters. After increasing or adjusting the value of the parameters according to response message 345, the network entity 105-b and the UE 115-b may perform wireless communications 310 according to the adjusted parameters (e.g., parameters 320). FIGS. 4-6 provide illustrative examples of transition procedure 340 with respect to specific parameters. Although FIGS. 4-6 present separate transition procedures, any aspects of FIGS. 4-6 may be combined or implemented by a wireless communications system 300.

In some implementations, a network entity 105-b may also maintain timers such that the network entity 105-b may adjust transmission or reception parameters to match the UE 115-b. For example, the network entity 105-b may maintain synchronized timers with the UE 115-b. Additionally, or alternatively, the network entity 105-b may adjust similar parameters at the network entity 105-b based on thresholds associated with the UE 115-b, and may be able to adjust uplink or downlink procedures to match the adjusted parameters at the UE 115-b.

FIGS. 4A and 4B show examples of transition procedures 400 and 401, respectively, that support dynamic MIMO and carrier aggregation communication configurations in accordance with one or more aspects of the present disclosure. For example, the transition procedures 400 and 401 may be examples of transition procedures as described herein, including with reference to FIG. 3. The techniques described in the context of the transition procedures 400 and 401 may enable a UE to adjust a MIMO configuration, a quantity of transmit chains, or both based on timers configured by the network entity, where the UE and the network entity may be examples of corresponding devices as described herein, including with reference to FIGS. 1-3.

As discussed with respect to FIG. 3, a UE may receive, via SIB, RRC signaling, DCI, or any combination thereof, one or more timers associated with multiple parameters at the UE, such as an uplink MIMO configuration or quantity of transmit chains. The UE may, based on expiry of the timers, decrease one or more parameters of the multiple parameters, as described further in transition procedures 400 and 401.

With respect to transition procedure 400 of FIG. 4A, a UE may initiate a timer associated with an uplink MIMO configuration, a timer associated with a quantity of transmit chains, or the like. For example, the UE may operate according to an uplink MIMO configuration 405. The UE may initiate a timer, such as a timer associated with a single transmit chain. After some duration with no uplink data, or some duration with an uplink data rate below a threshold, the UE 115-a may automatically perform transition 410 such that the UE may operate according to an uplink SISO configuration 415 with a single transmit chain configured. In some cases, the UE may use a single transmit chain SRS configuration (e.g., as a fallback or default). That is, the UE may automatically transition to a SISO configuration based on uplink data inactivity, which may lead to power savings at the UE and lower overhead signaling. If the UE has uplink data to transmit, such as if the uplink data satisfies a threshold, the UE may request a greater quantity of transmit chains or a different MIMO configuration via a request message, which may be transmitted via UCI or MAC-CE, as described further with reference to FIG. 2. A network entity may send a response message, via DCI or MAC-CE, indicating for the UE to adjust the quantity of transmit chains or the MIMO configuration based on the request message. The UE may adjust the quantity of transmit chains or the MIMO configuration. For example, the UE may perform transition 420 based on the response message and may transition to the uplink MIMO configuration 405.

With respect to transition procedure 401 of FIG. 4B, a UE may initiate multiple timers associated with a quantity of transmit chains, such that the UE may undergo a hierarchical transmit change adjustment based on the timers. For example, if the UE has four transmit chains 425 configured, the UE may initiate a first timer. After some duration with no or little uplink data on one or more secondary transmit chains at the UE (e.g., based on expiry of the timer), the UE may perform transition 430 and begin operating in accordance with two transmit chains 435. The UE may initiate a second timer and the UE may, based on expiry of the second timer, if there is little to no uplink data on one or more secondary transmit chains after some duration associated with the second timer, perform transition 440 and begin operating in accordance with one transmit chain 445. Although four transmit chains 425 may provide an illustrative example, the hierarchical fallback of transmit chains may be extended to any quantity of transmit chains. Further, the UE may also maintain timers associated with transitions that may skip some quantity of transmit chains. For example, the UE may maintain a timer that, based on expiry of the timer, may indicate for the UE to transition from four transmit chains 425 to one transmit chain 445. That is, the UE may automatically transition to lower quantities of transmit chain based on uplink data inactivity, which may lead to power savings at the UE and lower overhead signaling.

If the UE has some amount of uplink data to transmit, such as if the uplink data satisfies a threshold, the UE may request a greater quantity of transmit chains via a request message, which may be transmitted via UCI or MAC-CE, as described further with reference to FIG. 2. A network entity may send a response message, via DCI or MAC-CE, indicating for the UE to adjust the quantity of transmit chains or the MIMO configuration based on the request message. The UE may adjust the quantity of transmit chains or the MIMO configuration. For example, the UE may perform transition 450 based on the response message and may transition from one transmit chain 445 to two transmit chains 435. Additionally, or alternatively, the UE may perform transition 455 and transition from two transmit chains 435 to four transmit chains 425. Additionally, or alternatively, the UE may transition from one transmit chain 445 to four transmit chains 425 based on the indication in the response message. That is, the request and response transition between transmit chains may not follow hierarchical rules, may follow hierarchical rules, or, additionally, or alternatively, may extend beyond four transmit chains 425.

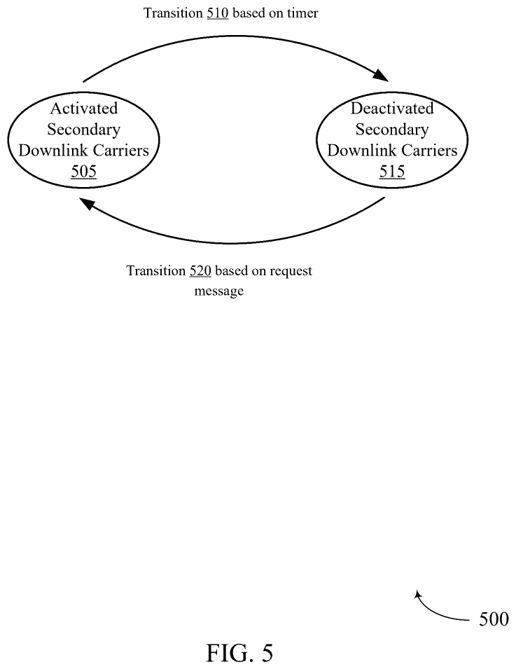

FIG. 5 shows an example of a transition procedure 500 that supports dynamic MIMO and carrier aggregation communication configurations in accordance with one or more aspects of the present disclosure. For example, the transition procedure 500 may be an example of a transition procedure as described herein, including with reference to FIG. 3. The techniques described in the context of the transition procedure 500 enable a UE to adjust a downlink carrier aggregation configuration based on timers configured by a network entity, where the UE and the network entity may be examples of corresponding devices as described herein, including with reference to FIGS. 1-3.

As discussed with respect to FIG. 3, a UE may receive, via SIB, RRC signaling, DCI, or any combination thereof, one or more timers associated with multiple parameters at the UE, such as parameters associated with a downlink carrier aggregation configuration. The UE may, based on expiry of the timers, decrease one or more parameters of the multiple parameters, as described further in transition procedure 500.

For example, a UE may be operating in accordance with activated secondary downlink carriers 505. The UE may initiate one or more timers associated with the downlink carrier aggregation configuration. After some duration with no downlink data on one or more of the activated secondary downlink carriers 505 (e.g., based on expiry of a first timer), the UE may perform transition 510 and may deactivate one or more secondary downlink carriers 515. For example, a UE may transition, at transition 510, from a downlink carrier configuration with two activated downlink carriers (one activated secondary downlink carrier 505) and two configured downlink carriers (2A2C mode) to a downlink carrier configuration with one activated downlink carriers (e.g., one deactivated secondary downlink carrier 515) and two configured downlink carriers (1A2C mode). In some examples, the downlink carrier aggregation configuration may support more than two configured downlink carriers. The UE may deactivate secondary downlink carriers 515 in any step size. That is, the transition 510 may be associated with any quantity of deactivated secondary downlink carriers 515. Further, the transition 510 may be performed iteratively or according to multiple timers, such as in FIG. 4B.

For example, a UE may be configured with four downlink carriers and may maintain four activated secondary downlink carriers 505 (e.g., which may be referred to as 4A4C). In some examples, a UE may maintain three timers and may, based on expiry of each timer, perform a transition 510 and deactivate one secondary downlink carrier of the four activated secondary downlink carriers 505 (e.g., a step size of one). That is, after expiry of a first timer, the UE may transition from 4A4C to 3A4C. After expiry of a second timer, the UE may transition from 3A4C to 2A4C. After expiry of a third timer, the UE may transition from 2A4C to 1A4C. Additionally, or alternatively, the UE may maintain two timers and may, based on expiry of each timer, perform a transition 510 and deactivate half the secondary downlink carriers of the activated secondary downlink carriers 505 (e.g., a step size of two). That is, after expiry of a first timer, the UE may transition from 4A4C to 2A4C. After expiry of a second timer, the UE may transition from 2A4C to 1A4C. Additionally, or alternatively, the UE may maintain one time and may, based on expiry of the timer, transition to a lowest downlink carrier aggregation configuration. That is, after expiry of the timer, the UE may transition from 4A4C to 1A4C (e.g., step size of four). Any other step size or transition jump may be associated with a timer at the UE.

In some cases, the network entity may provide an indication to the UE for which secondary downlink carriers to deactivate, and in what order. For example, the network entity may provide the UE with hierarchical indices of carriers, which the UE may use to deactivate identified secondary downlink carriers based on their indices. In some cases, the network entity may configure different UEs with different hierarchical indices to support load balancing ta the network entity. The indication of the order of deactivation for the secondary downlink carriers may be transmitted with the control signaling indication the timers, or via separate control signaling, which may include a SIB, RRC signaling, or DCI.

If there is downlink data, such as if the UE has a higher downlink data threshold, the UE may request a greater quantity of transmit chains via a request message, which may be transmitted via UCI or MAC-CE, as described further with reference to FIG. 2. A network entity may send a response message, via DCI or MAC-CE, indicating for the UE to adjust the quantity of transmit chains or the MIMO configuration based on the request message. The UE may adjust the quantity of transmit chains or the MIMO configuration. For example, the UE may perform transition 520 based on the response message and may transition from a configuration with at least one deactivated secondary downlink carriers 515 to a configuration where at least one of the deactivated secondary downlink carriers 515 may be activated and may be an activated secondary downlink carrier 505.

Although transition procedure 500 describes deactivating secondary downlink carriers, the UE may also reconfigure the quantity of configured secondary downlink carriers based on timers, or may request the network entity to reconfigure or configure the quantity of configured secondary downlink carriers. For example, the UE may, at transition 510, move from 2A4C to 2A2C, based on expiry of a timer. Reconfiguring the secondary downlink carriers may be associated with more time and power consuming transitions 510 and 520 when compared to activating or deactivating the configured secondary downlink carriers. However, reconfiguring the secondary downlink carriers may be associated with even greater power consumption and more efficient communications, particularly if done after long durations of time.

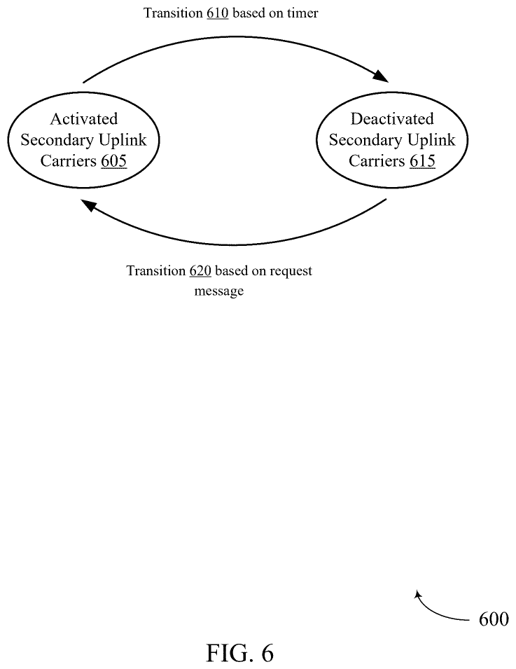

FIG. 6 shows an example of a transition procedure 600 that supports dynamic MIMO and carrier aggregation communication configurations in accordance with one or more aspects of the present disclosure. For example, the transition procedure 600 may be an example of a transition procedure as described herein, including with reference to FIG. 3. The techniques described in the context of the transition procedure 600 enable a UE to adjust an uplink carrier aggregation configuration based on timers configured by a network entity, where the UE and the network entity may be examples of corresponding devices as described herein, including with reference to FIGS. 1-3.

As discussed with respect to FIG. 3, a UE may receive, via SIB, RRC signaling, DCI, or any combination thereof, one or more timers associated with multiple parameters at the UE, such as parameters associated with an uplink carrier aggregation configuration. The UE may, based on expiry of the timers, decrease one or more parameters of the multiple parameters, as described further in transition procedure 600.

For example, a UE may be operating in accordance with activated secondary uplink carriers 605. The UE may initiate one or more timers associated with the uplink carrier aggregation configuration. After some duration with no uplink data on one or more of the activated secondary uplink carriers 605 (e.g., based on expiry of a first timer), the UE may perform transition 610 and may deactivate one or more secondary uplink carriers 615. For example, a UE may transition, at transition 610, from an uplink carrier configuration with two activated uplink carriers (one activated secondary uplink carrier 605) and two configured uplink carriers (2A2C mode) to an uplink carrier configuration with one activated uplink carriers (e.g., one deactivated secondary uplink carrier 615) and two configured uplink carriers (1A2C mode). In some examples, the uplink carrier aggregation configuration may support more than two configured uplink carriers. The UE may deactivate secondary uplink carriers 615 in any step size. That is, the transition 510 may be associated with any quantity of deactivated secondary uplink carriers 615. Further, the transition 610 may be performed iteratively or according to multiple timers, such as in FIG. 4B.

For example, a UE may be configured with four uplink carriers and may maintain four activated secondary uplink carriers 605 (e.g., 4A4C). In some examples, a UE may maintain three timers and may, based on expiry of each timer, perform a transition 610 and deactivate one secondary uplink carrier of the four activated secondary uplink carriers 605 (e.g., a step size of one). That is, after expiry of a first timer, the UE may transition from 4A4C to 3A4C. After expiry of a second timer, the UE may transition from 3A4C to 2A4C. After expiry of a third timer, the UE may transition from 2A4C to 1A4C. Additionally, or alternatively, the UE may maintain two timers and may, based on expiry of each timer, perform a transition 610 and deactivate half the secondary uplink carriers of the activated secondary uplink carriers 605 (e.g., a step size of two). That is, after expiry of a first timer, the UE may transition from 4A4C to 2A4C. After expiry of a second timer, the UE may transition from 2A4C to 1A4C. Additionally, or alternatively, the UE may maintain one time and may, based on expiry of the timer, transition to a lowest uplink carrier aggregation configuration. That is, after expiry of the timer, the UE may transition from 4A4C to 1A4C (e.g., step size of four). Any other step size or transition jump may be associated with a timer at the UE.

In some cases, the network entity may provide an indication to the UE for which secondary uplink carriers to deactivate, and in what order. For example, the network entity may provide the UE with hierarchical indices of carriers, which the UE may use to deactivate identified secondary uplink carriers based on their indices. In some cases, the network entity may configure different UEs with different hierarchical indices to support load balancing ta the network entity. The indication of the order of deactivation for the secondary uplink carriers may be transmitted with the control signaling indication the timers, or via separate control signaling, which may include a SIB, RRC signaling, or DCI.

If there is uplink data, such as if the UE has a higher uplink data threshold, the UE may request a greater quantity of transmit chains via a request message, which may be transmitted via UCI or MAC-CE, as described further with reference to FIG. 2. A network entity may send a response message, via DCI or MAC-CE, indicating for the UE to adjust the quantity of transmit chains or the MIMO configuration based on the request message. The UE may adjust the quantity of transmit chains or the MIMO configuration. For example, the UE may perform transition 520 based on the response message and may transition from a configuration with at least one deactivated secondary uplink carriers 615 to a configuration where at least one of the deactivated secondary uplink carriers 615 may be activated and may be an activated secondary uplink carrier 605.

Although transition procedure 600 describes deactivating secondary uplink carriers, the UE may also reconfigure the quantity of configured secondary uplink carriers based on timers, or may request the network entity to reconfigure or configure the quantity of configured secondary uplink carriers. For example, the UE may, at transition 610, move from 2A4C to 2A2C, based on expiry of a timer. Reconfiguring the secondary uplink carriers may be associated with more time and power consuming transitions 610 and 620 when compared to activating or deactivating the configured secondary uplink carriers. However, reconfiguring the secondary uplink carriers may be associated with even greater power consumption and more efficient communications, particularly if done after long durations of time.

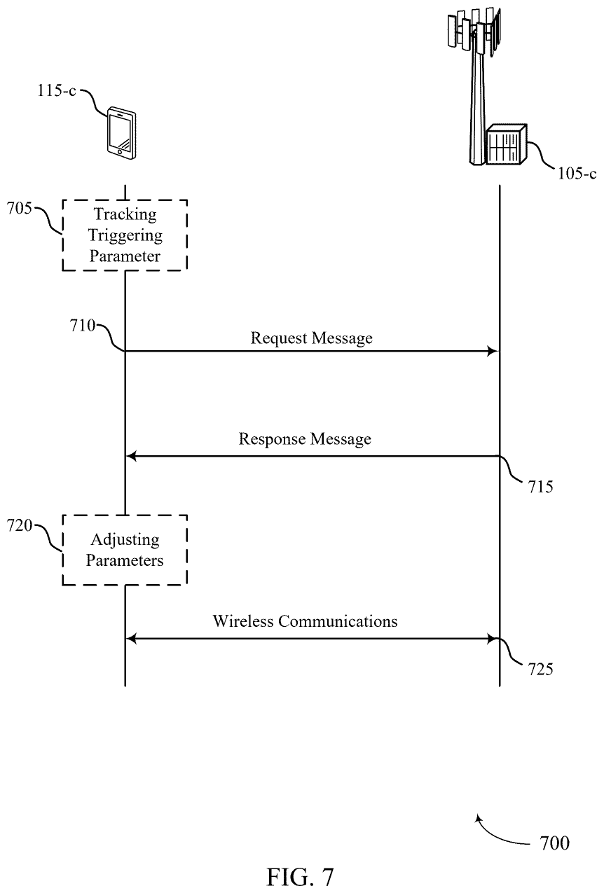

FIG. 7 shows an example of a process flow 700 that supports dynamic MIMO and carrier aggregation communication configurations in accordance with one or more aspects of the present disclosure. For example, the process flow 700 may include a UE 115-c and a network entity 105-c, which may be examples of the corresponding devices as described herein, including with reference to FIGS. 1-3. The techniques described in the context of the process flow 700 may enable the UE 115-c to request to adjust parameters associated with the MIMO and carrier aggregation configuration, as described further with respect to FIG. 2.

In some implementations, at 705, the UE 115-c may track multiple triggering parameters at the UE 115-c. In some cases, the multiple triggering parameters may include an uplink data rate, one or more latency thresholds, one or more channel conditions at the UE 115-c, power consumption at the UE 115-c, one or more application-based data rates, one or more application-based latency thresholds (e.g., requirements), a position of the UE 115-c, or any combination thereof. In some examples, the one or more channel conditions may include an uplink transmission power, a channel path loss, an MCS allocation, a resource block allocation, or any combination thereof. In some cases, the UE 115-c may track the multiple triggering parameters by inputting one or more detected triggering parameter values associated with the plurality of triggering parameters into a ML model, where an output of the ML model may correspond to one or more parameters associated with a MIMO configuration, a carrier aggregation configuration, or both, as discussed further at 710.

At 710, the UE 115-c may transmit, and the network entity 105-c may obtain, a request message comprising a request to adjust one or more parameters associated with a MIMO configuration, a carrier aggregation configuration, or both in accordance with one or more triggering parameters satisfying a threshold. The threshold may comprise one or more parameter-specific thresholds. In some implementations, the multiple triggering parameters, as described at 705, may include the one or more triggering parameters, where the UE 115-c may transmit the request message in accordance with the one or more triggering parameters of the multiple triggering parameters satisfying the threshold. In some cases, the network entity 105-c may obtain the request message in accordance with one or more capabilities of the UE 115-c. For example, the one or more capabilities may include a tracking capability of the UE 115-c, as described at 705.

In some cases, the one or more parameters may include a quantity of transmit chains, a quantity of secondary downlink carriers, a quantity of secondary uplink carriers, activation or deactivation of one or more secondary downlink carriers of the secondary downlink carriers, activation or deactivation of one or more secondary uplink carriers of the secondary uplink carriers, activation or deactivation of one or more supplementary uplink carriers, or any combination thereof. In some implementations, the UE 115-c may transmit the request message via a UCI message or a MAC-CE. In some cases, the request to adjust the one or more parameters includes a request to adjust at least one first parameter associated with the MIMO configuration and to adjust at least one second parameter associated with the carrier aggregation configuration, where the one or more parameters comprises the at least one first parameter and the at least one second parameter. In some cases, the UE 115-c may transmit multiple request messages at 710. In some examples, each request message may be associated with a parameter of the one or more parameters. That is, examples of the one or more parameters may be MIMO parameters and carrier aggregation parameters, thus configuration may be adjusted separately for MIMO or carrier aggregation, or jointly for both MIMO and carrier aggregation, by a single or multiple requests.

At 715, the UE 115-c may receive, and the network entity 105-c may output, a response message, where the response message may indicate for the UE 115-c to adjust the one or more parameters in accordance with the request message, as described at 710. In some implementations, the UE 115-c may receive the response message via a DCI message or a MAC-CE.

In some implementations, at 720, the UE 115-c may adjust the one or more parameters to one or more adjusted parameters in accordance with receiving the response message.

At 725, the UE 115-c and the network entity 105-c may perform wireless communications in accordance with the one or more adjusted parameters, as discussed at 720. That is, performing the wireless communications at 725 may be in accordance with adjusting the one or more parameters, as described at 720.

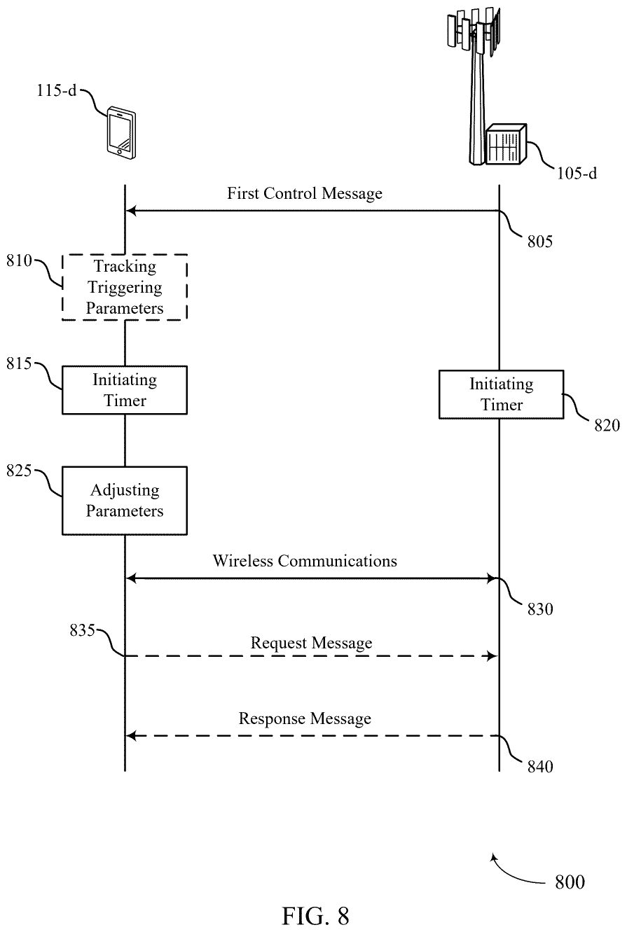

Although described separately herein, aspects of process flow 700 may implement, or be implemented by, aspects of process flow 800, as described with reference to FIG. 8.

FIG. 8 shows an example of a process flow 800 that supports dynamic MIMO and carrier aggregation communication configurations in accordance with one or more aspects of the present disclosure. For example, the process flow 800 may include a UE 115-d and a network entity 105-d, which may be examples of the corresponding devices as described herein, including with reference to FIG. 1-3. The techniques described in the context of the process flow 800 may enable the UE 115-d to adjust parameters associated with the MIMO and carrier aggregation configuration based on timers configured by the network entity 105-d.

At 805, the UE 115-d may receive, and the network entity 105-d may output, a first control message indicating one or more timers associated with one or more parameters, the one or more parameters associated with a MIMO configuration, a carrier aggregation configuration, or both. In some cases, the UE 115-d may receive (and the network entity 105-d may output), via the first control message or a second message, an indication of multiple priority levels associated with one or more secondary carriers, wherein the one or more secondary carriers include one or more secondary uplink carriers, one or more secondary downlink carriers, or any combination thereof, and where the one or more parameters include the one or more secondary carriers. In some cases, the first control message may include a SIB, RRC signaling, DCI, or any combination thereof. In some cases, the network entity 105-d may output the first control message in accordance with one or more capabilities of the UE 115-d. For example, the one or more capabilities may include a tracking capability of the UE 115-d, as described at 810.

In some implementations, at 810, the UE 115-d may track the one or more triggering parameters at the UE 115-d. The one or more triggering parameters may include an uplink data rate, one or more latency thresholds (e.g., requirements), one or more channel conditions at the UE 115-d, power consumption at the UE 115-d, one or more application-based data rates, one or more application-based latency threshold (e.g., requirements), a position of the UE 115-d, or any combination thereof. In some cases, the one or more channel conditions may include an uplink transmission power, a channel path loss, an MCS allocation, a resource block allocation, or any combination thereof. In some cases, the UE 115-d may track the multiple triggering parameters by inputting one or more detected triggering parameter values associated with the plurality of triggering parameters into a ML model, where an output of the ML model may correspond to the one or more parameters associated with the MIMO configuration.

At 815, the UE 115-d may initiate, in accordance with receiving or outputting the first control message at 805, respectively, a first timer of the one or more timers in accordance with the one or more triggering parameters satisfying a threshold. The threshold may comprise one or more parameter-specific thresholds.

At 820, the network entity 105-d may initiate, in accordance with outputting the first control message at 805, respectively, a first timer of the one or more timers in accordance with the one or more triggering parameters satisfying a threshold. The threshold may comprise one or more parameter-specific thresholds. The first timer initiated by the network entity 105-d may be the same or may be synchronized to the first timer initiated by the UE 115-d at 815.

At 825, the UE 115-d may adjust the one or more parameters in accordance with expiry of the first timer. In some cases, the UE 115-d may adjust the one or more parameters by decreasing a quantity of transmit chains, decreasing a quantity of secondary carriers, deactivating one or more secondary carriers, or any combination thereof in accordance with the expiry of the first timer, where the secondary carriers may include one or more secondary downlink carriers, one or more secondary uplink carriers, or any combination thereof. In some cases, the one or more parameters may include one or more secondary carriers, and the UE 115-d may deactivate at least one secondary carrier of the one or more secondary carriers in accordance with the plurality of priority levels, as described further with respect to 805, and in accordance with the expiry of the first timer. In some cases, the UE 115-c may adjust the one or more parameters in accordance with expiry of a second timer of the one or more timers, the second timer different from the first timer.

In some implementations, the one or more parameters may include a quantity of transmit chains. In some cases, to adjust the one or more parameters, the UE 115-d may decrease the quantity of transmit chains from a first quantity to a second quantity in accordance with the expiry of the first timer of the one or more timers, where the second quantity is associated with the first timer. That is, examples of the one or more parameters may be MIMO parameters and carrier aggregation parameters, thus configuration may be adjusted separately for MIMO or carrier aggregation, or jointly for both MIMO and carrier aggregation, by a single or multiple requests. In some examples, the UE 115-d may decrease the quantity of transmit chains from the second quantity to a third quantity in accordance with expiry of a second timer of the one or more timers, where the third quantity is associated with the second timer. In some cases, the UE 115-d may adjust the one or more parameters by decreasing the quantity of transmit chains to a threshold quantity based on expiry of the first timer. In some examples, the UE 115-d may transition from a first MIMO configuration to a second MIMO configuration in accordance with decreasing the quantity of transmit chains to the threshold quantity.

At 830, the UE 115-d and the network entity 105-d may perform wireless communications in accordance with initiating the respective first timers, as described at 815 and 820, and in accordance with the MIMO configuration, the carrier aggregation configuration, or both corresponding to the one or more parameters.

At 835, the UE 115-d may transmit, and the network entity 105-d may obtain, a request message, via UCI or via a MAC-CE, including a request to increase the one or more parameters. At 840, the UE 115-d may receive, and the network entity 105-d may output, a response message, via DCI or via a second MAC-CE, in response to the request, where the response message indicates for the UE to increase the one or more parameters in accordance with the request message. In some cases, the steps described with respect to 835 and 840 may implement, or may be implemented by, aspects of process flow 700.

Although described separately herein, aspects of process flow 800 may implement, or be implemented by, aspects of process flow 700, as described with reference to FIG. 7.

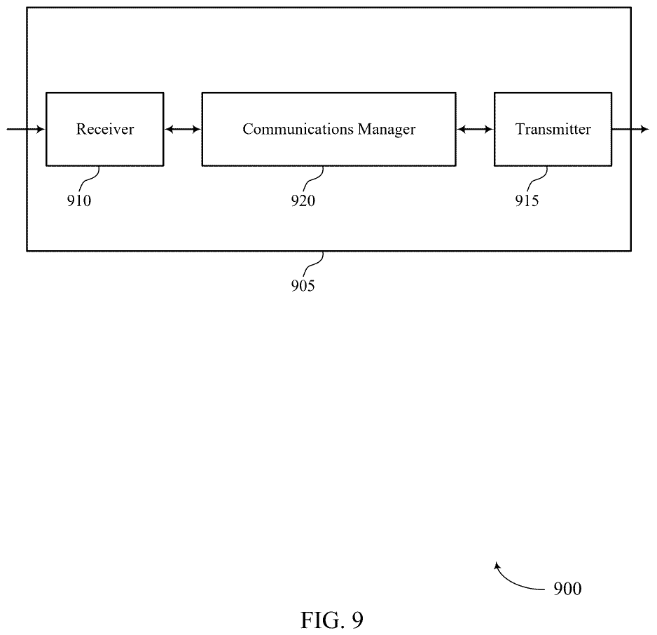

FIG. 9 shows a block diagram 900 of a device 905 that supports dynamic MIMO and carrier aggregation communication configurations in accordance with one or more aspects of the present disclosure. The device 905 may be an example of aspects of a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to dynamic MIMO and carrier aggregation communication configurations). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to dynamic MIMO and carrier aggregation communication configurations). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations or components thereof may be examples of means for performing various aspects of dynamic MIMO and carrier aggregation communication configurations as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for transmitting a request message including a request to adjust one or more parameters associated with a MIMO configuration, a carrier aggregation configuration, or both in accordance with one or more triggering parameters satisfying a threshold. The communications manager 920 is capable of, configured to, or operable to support a means for receiving a response message, where the response message indicates for the UE to adjust the one or more parameters in accordance with the request message. The communications manager 920 is capable of, configured to, or operable to support a means for performing wireless communications in accordance with one or more adjusted parameters.

Additionally, or alternatively, the communications manager 920 may support wireless communications in accordance with examples as disclosed herein. For example, the communications manager 920 is capable of, configured to, or operable to support a means for receiving a first control message indicating one or more timers associated with one or more parameters, the one or more parameters associated with a MIMO configuration, a carrier aggregation configuration, or both. The communications manager 920 is capable of, configured to, or operable to support a means for initiating, in accordance with receiving the first control message, a first timer of the one or more timers in accordance with one or more triggering parameters satisfying a threshold. The communications manager 920 is capable of, configured to, or operable to support a means for adjusting the one or more parameters in accordance with expiry of the first timer.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced power consumption and more efficient utilization of communication resources.

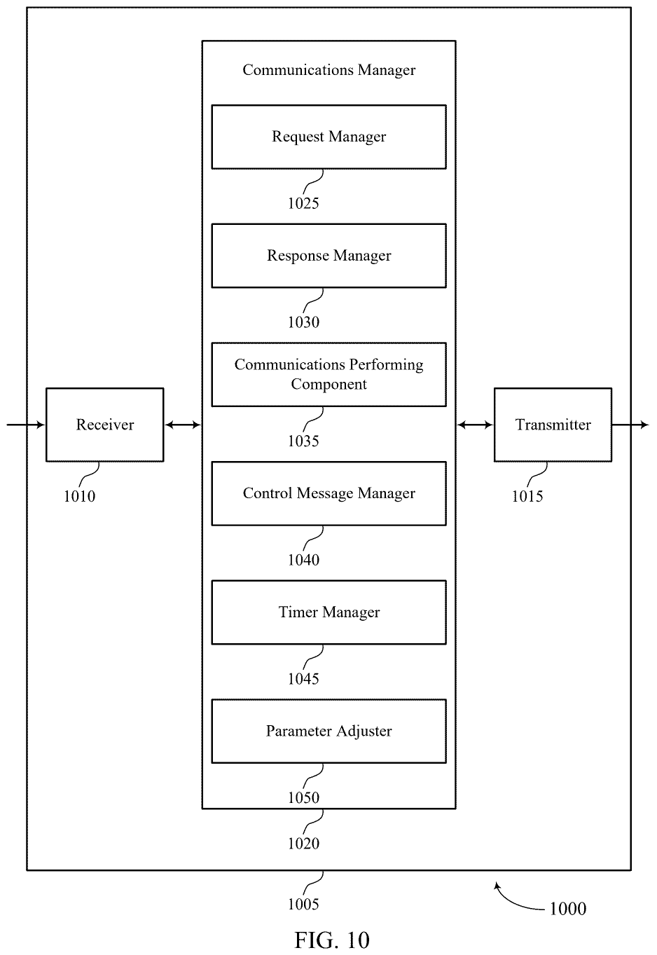

FIG. 10 shows a block diagram 1000 of a device 1005 that supports dynamic MIMO and carrier aggregation communication configurations in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to dynamic MIMO and carrier aggregation communication configurations). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to dynamic MIMO and carrier aggregation communication configurations). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of dynamic MIMO and carrier aggregation communication configurations as described herein. For example, the communications manager 1020 may include a request manager 1025, a response manager 1030, a communications performing component 1035, a control message manager 1040, a timer manager 1045, a parameter adjuster 1050, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The request manager 1025 is capable of, configured to, or operable to support a means for transmitting a request message including a request to adjust one or more parameters associated with a MIMO configuration, a carrier aggregation configuration, or both in accordance with one or more triggering parameters satisfying a threshold. The response manager 1030 is capable of, configured to, or operable to support a means for receiving a response message, where the response message indicates for the UE to adjust the one or more parameters in accordance with the request message. The communications performing component 1035 is capable of, configured to, or operable to support a means for performing wireless communications in accordance with one or more adjusted parameters.

Additionally, or alternatively, the communications manager 1020 may support wireless communications in accordance with examples as disclosed herein. The control message manager 1040 is capable of, configured to, or operable to support a means for receiving a first control message indicating one or more timers associated with one or more parameters, the one or more parameters associated with a MIMO configuration, a carrier aggregation configuration, or both. The timer manager 1045 is capable of, configured to, or operable to support a means for initiating, in accordance with receiving the first control message, a first timer of the one or more timers in accordance with one or more triggering parameters satisfying a threshold. The parameter adjuster 1050 is capable of, configured to, or operable to support a means for adjusting the one or more parameters in accordance with expiry of the first timer.

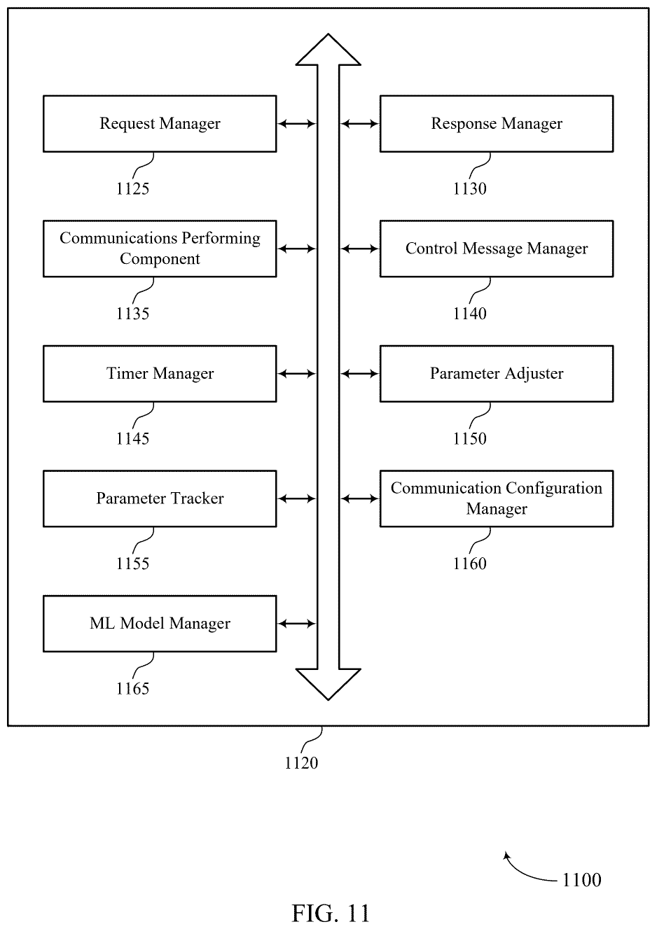

FIG. 11 shows a block diagram 1100 of a communications manager 1120 that supports dynamic MIMO and carrier aggregation communication configurations in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of dynamic MIMO and carrier aggregation communication configurations as described herein. For example, the communications manager 1120 may include a request manager 1125, a response manager 1130, a communications performing component 1135, a control message manager 1140, a timer manager 1145, a parameter adjuster 1150, a parameter tracker 1155, a communication configuration manager 1160, an ML model manager 1165, or any combination thereof. Each of these components, or components or subcomponents thereof (e.g., one or more processors, one or more memories), may communicate, directly or indirectly, with one another (e.g., via one or more buses).

The communications manager 1120 may support wireless communications in accordance with examples as disclosed herein. The request manager 1125 is capable of, configured to, or operable to support a means for transmitting a request message including a request to adjust one or more parameters associated with a MIMO configuration, a carrier aggregation configuration, or both in accordance with one or more triggering parameters satisfying a threshold. The response manager 1130 is capable of, configured to, or operable to support a means for receiving a response message, where the response message indicates for the UE to adjust the one or more parameters in accordance with the request message. The communications performing component 1135 is capable of, configured to, or operable to support a means for performing wireless communications in accordance with one or more adjusted parameters.

In some examples, the parameter adjuster 1150 is capable of, configured to, or operable to support a means for adjusting the one or more parameters to the one or more adjusted parameters in accordance with receiving the response message, where performing the wireless communications is in accordance with adjusting the one or more parameters.

In some examples, the parameter tracker 1155 is capable of, configured to, or operable to support a means for tracking a set of multiple triggering parameters at the UE, where the plurality of triggering parameters comprises the one or more triggering parameters and transmitting the request message is in accordance with the one or more triggering parameters of the plurality of triggering parameters satisfying the threshold.

In some examples, the set of multiple triggering parameters include an uplink data rate, one or more latency thresholds, one or more channel conditions at the UE, power consumption at the UE, one or more application-based data rates, one or more application-based latency thresholds (e.g., requirements), a position of the UE, or any combination thereof. In some examples, the one or more channel conditions include an uplink transmission power, a channel path loss, a MCS allocation, a resource block allocation, or any combination thereof.

In some examples, to support tracking the set of multiple triggering parameters at the UE, the ML model manager 1165 is capable of, configured to, or operable to support a means for inputting one or more detected triggering parameter values associated with the set of multiple triggering parameters into a machine learning model, where an output of the machine learning model corresponds to the one or more parameters.

In some examples, the one or more parameters include a quantity of transmit chains, a quantity of secondary downlink carriers, a quantity of secondary uplink carriers, activation or deactivation of one or more secondary downlink carriers of the secondary downlink carriers, activation or deactivation of one or more secondary uplink carriers of the secondary uplink carriers, activation or deactivation of one or more supplementary uplink carriers, or any combination thereof.

In some examples, the request message is transmitted via UCI, or a MAC-CE.

In some examples, the response message is received via DCI or a MAC-CE.

In some examples, the request to adjust the one or more parameters include a request to adjust at least one first parameter associated with the MIMO configuration and to adjust at least one second parameter associated with the carrier aggregation configuration. In some examples, the one or more parameters includes the at least one first parameter and the at least one second parameter.

Additionally, or alternatively, the communications manager 1120 may support wireless communications in accordance with examples as disclosed herein. The control message manager 1140 is capable of, configured to, or operable to support a means for receiving a first control message indicating one or more timers associated with one or more parameters, the one or more parameters associated with a MIMO configuration, a carrier aggregation configuration, or both. The timer manager 1145 is capable of, configured to, or operable to support a means for initiating, in accordance with receiving the first control message, a first timer of the one or more timers in accordance with one or more triggering parameters satisfying a threshold. The parameter adjuster 1150 is capable of, configured to, or operable to support a means for adjusting the one or more parameters in accordance with expiry of the first timer.

In some examples, the parameter tracker 1155 is capable of, configured to, or operable to support a means for tracking the one or more triggering parameters at the UE, where the one or more triggering parameters include an uplink data rate, one or more latency thresholds (e.g., requirements), one or more channel conditions at the UE, power consumption at the UE, one or more application-based data rates, one or more application-based latency thresholds (e.g., requirements), a position of the UE, or any combination thereof, where the one or more channel conditions include an uplink transmission power, a channel path loss, an MCS allocation, a resource block allocation, or any combination thereof.

In some examples, to support tracking the one or more triggering parameters at the UE, the ML model manager 1165 is capable of, configured to, or operable to support a means for inputting one or more detected triggering parameter values associated with the one or more triggering parameters into a machine learning model, where an output of the machine learning model corresponds to the one or more parameters.

In some examples, the request manager 1125 is capable of, configured to, or operable to support a means for transmitting a request message, via UCI or via a MAC-CE, including a request to increase the one or more parameters. In some examples, the response manager 1130 is capable of, configured to, or operable to support a means for receiving a response message, via DCI or via a second MAC-CE, in response to the request, where the response message indicates for the UE to increase the one or more parameters in accordance with the request message.

In some examples, to support adjusting the one or more parameters, the parameter adjuster 1150 is capable of, configured to, or operable to support a means for decreasing a quantity of transmit chains, decreasing a quantity of secondary carriers, deactivation of one or more secondary carriers, or any combination thereof in accordance with the expiry of the first timer, where the secondary carriers include one or more secondary downlink carriers, one or more secondary uplink carriers, or any combination thereof.

In some examples, to support adjusting the one or more parameters, the control message manager 1140 is capable of, configured to, or operable to support a means for receiving, via the first control message or a second message, an indication of a set of multiple priority levels associated with one or more secondary carriers, where the one or more secondary carriers include one or more secondary uplink carriers, one or more secondary downlink carriers, or any combination thereof and where the one or more parameters include the one or more secondary carriers. In some examples, to support adjusting the one or more parameters, the parameter adjuster 1150 is capable of, configured to, or operable to support a means for deactivating at least one secondary carrier of one or more secondary carriers in accordance with the set of multiple priority levels and in accordance with the expiry of the first timer, where the one or more parameters include the one or more secondary carriers.

In some examples, to support adjusting the one or more parameters, the parameter adjuster 1150 is capable of, configured to, or operable to support a means for decreasing the quantity of transmit chains from a first quantity to a second quantity in accordance with the expiry of the first timer of the one or more timers, where the second quantity is associated with the first timer. In some examples, to support adjusting the one or more parameters, the parameter adjuster 1150 is capable of, configured to, or operable to support a means for decreasing the quantity of transmit chains from the second quantity to a third quantity in accordance with expiry of a second timer of the one or more timers, where the third quantity is associated with the second timer.

In some examples, to support adjusting the one or more parameters, the parameter adjuster 1150 is capable of, configured to, or operable to support a means for decreasing the quantity of transmit chains to a threshold quantity after expiry of the first timer. In some examples, to support adjusting the one or more parameters, the communication configuration manager 1160 is capable of, configured to, or operable to support a means for transitioning from a first MIMO configuration to a second MIMO configuration in accordance with decreasing the quantity of transmit chains to the threshold quantity.

In some examples, the parameter adjuster 1150 is capable of, configured to, or operable to support a means for adjusting the one or more parameters in accordance with expiry of a second timer of the one or more timers, the second timer different from the first timer.

In some examples, the first control message includes a system information block, radio resource control signaling, DCI, or any combination thereof.

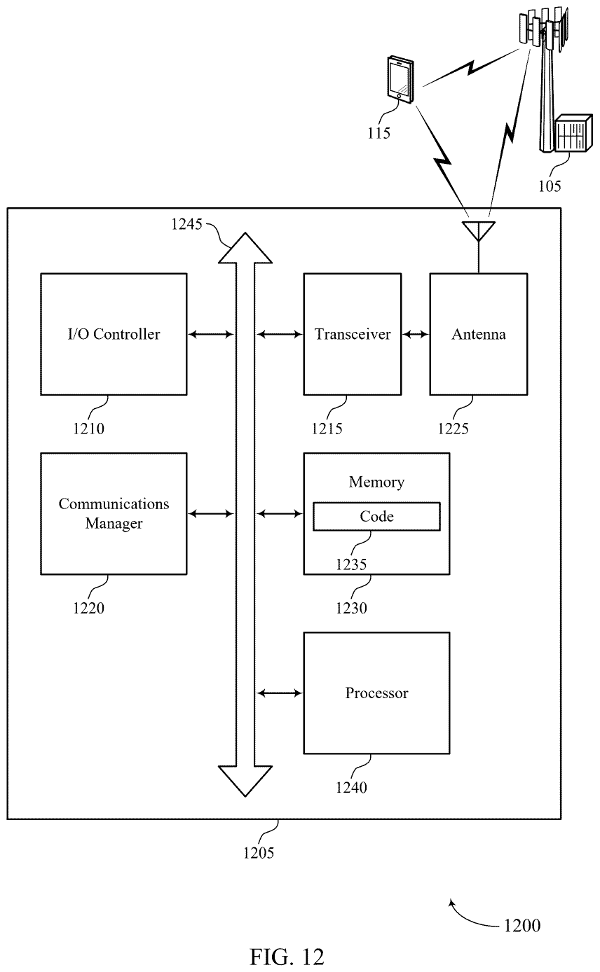

FIG. 12 shows a diagram of a system 1200 including a device 1205 that supports dynamic MIMO and carrier aggregation communication configurations in accordance with one or more aspects of the present disclosure. The device 1205 may be an example of or include components of a device 905, a device 1005, or a UE 115 as described herein. The device 1205 may communicate (e.g., wirelessly) with one or more other devices (e.g., network entities 105, UEs 115, or a combination thereof). The device 1205 may include components for bi-directional voice and data communications including components for transmitting and receiving communications, such as a communications manager 1220, an input/output (I/O) controller, such as an I/O controller 1210, a transceiver 1215, one or more antennas 1225, at least one memory 1230, code 1235, and at least one processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna. However, in some other cases, the device 1205 may have more than one antenna, which may be capable of concurrently transmitting or receiving multiple wireless transmissions. The transceiver 1215 may communicate bi-directionally via the one or more antennas 1225 using wired or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The at least one memory 1230 may include random access memory (RAM) and read-only memory (ROM). The at least one memory 1230 may store computer-readable, computer-executable, or processor-executable code, such as the code 1235. The code 1235 may include instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may include, among other things, a basic I/O system (BIOS) which may control basic hardware or software operation such as the interaction with peripheral components or devices.

The at least one processor 1240 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting dynamic MIMO and carrier aggregation communication configurations). For example, the device 1205 or a component of the device 1205 may include at least one processor 1240 and at least one memory 1230 coupled with or to the at least one processor 1240, the at least one processor 1240 and the at least one memory 1230 configured to perform various functions described herein.

In some examples, the at least one processor 1240 may include multiple processors and the at least one memory 1230 may include multiple memories. One or more of the multiple processors may be coupled with one or more of the multiple memories, which may, individually or collectively, be configured to perform various functions described herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. For example, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code 1235 (e.g., processor-executable code) stored in the at least one memory 1230 or otherwise, to perform one or more of the functions described herein.

The communications manager 1220 may support wireless communications in accordance with examples as disclosed herein. For example, the communications manager 1220 is capable of, configured to, or operable to support a means for transmitting a request message including a request to adjust one or more parameters associated with a MIMO configuration, a carrier aggregation configuration, or both in accordance with one or more triggering parameters satisfying a threshold. The communications manager 1220 is capable of, configured to, or operable to support a means for receiving a response message, where the response message indicates for the UE to adjust the one or more parameters in accordance with the request message. The communications manager 1220 is capable of, configured to, or operable to support a means for performing wireless communications in accordance with one or more adjusted parameters.

Additionally, or alternatively, the communications manager 1220 may support wireless communications in accordance with examples as disclosed herein. For example, the communications manager 1220 is capable of, configured to, or operable to support a means for receiving a first control message indicating one or more timers associated with one or more parameters, the one or more parameters associated with a MIMO configuration, a carrier aggregation configuration, or both. The communications manager 1220 is capable of, configured to, or operable to support a means for initiating, in accordance with receiving the first control message, a first timer of the one or more timers in accordance with one or more triggering parameters satisfying a threshold. The communications manager 1220 is capable of, configured to, or operable to support a means for adjusting the one or more parameters in accordance with expiry of the first timer.

By including or configuring the communications manager 1220 in accordance with examples as described herein, the device 1205 may support techniques for reduced latency, reduced power consumption, more efficient utilization of communication resources, improved coordination between devices, longer battery life, and improved utilization of processing capability.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of dynamic MIMO and carrier aggregation communication configurations as described herein, or the at least one processor 1240 and the at least one memory 1230 may be otherwise configured to, individually or collectively, perform or support such operations.

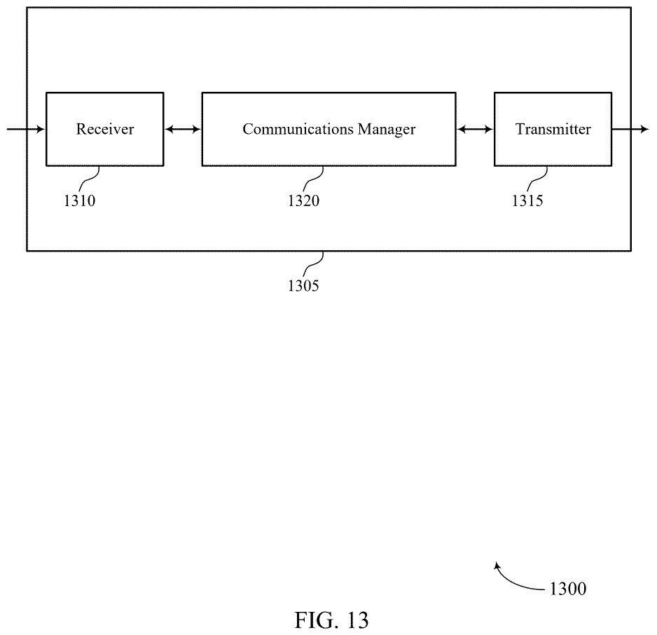

FIG. 13 shows a block diagram 1300 of a device 1305 that supports dynamic MIMO and carrier aggregation communication configurations in accordance with one or more aspects of the present disclosure. The device 1305 may be an example of aspects of a network entity 105 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to, individually or collectively, support or enable the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The communications manager 1320, the receiver 1310, the transmitter 1315, or various combinations or components thereof may be examples of means for performing various aspects of dynamic MIMO and carrier aggregation communication configurations as described herein. For example, the communications manager 1320, the receiver 1310, the transmitter 1315, or various combinations or components thereof may be capable of performing one or more of the functions described herein.

In some examples, the communications manager 1320, the receiver 1310, the transmitter 1315, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1320, the receiver 1310, the transmitter 1315, or various combinations or components thereof may be implemented in code (e.g., as communications management software or firmware) executed by at least one processor (e.g., referred to as a processor-executable code). If implemented in code executed by at least one processor, the functions of the communications manager 1320, the receiver 1310, the transmitter 1315, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1320 may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. For example, the communications manager 1320 is capable of, configured to, or operable to support a means for obtaining a request message including a request to adjust one or more parameters associated with a MIMO configuration, a carrier aggregation configuration, or both, where obtaining the request message is in accordance with one or more capabilities of a UE. The communications manager 1320 is capable of, configured to, or operable to support a means for outputting a response message in response to the request, where the response message indicates for the UE to adjust the one or more parameters in accordance with the request. The communications manager 1320 is capable of, configured to, or operable to support a means for performing wireless communications in accordance with one or more adjusted parameters.

Additionally, or alternatively, the communications manager 1320 may support wireless communications in accordance with examples as disclosed herein. For example, the communications manager 1320 is capable of, configured to, or operable to support a means for outputting a first control message indicating one or more timers associated with one or more parameters, the one or more parameters associated with a MIMO configuration, a carrier aggregation configuration, or both. The communications manager 1320 is capable of, configured to, or operable to support a means for initiating, in accordance with receiving the first control message, a first timer of the one or more timers in accordance with one or more triggering parameters satisfying a threshold and in accordance with outputting the first control message. The communications manager 1320 is capable of, configured to, or operable to support a means for performing wireless communications in accordance with initiating the first timer and the MIMO configuration, the carrier aggregation configuration, or both to the one or more parameters.

By including or configuring the communications manager 1320 in accordance with examples as described herein, the device 1305 (e.g., at least one processor controlling or otherwise coupled with the receiver 1310, the transmitter 1315, the communications manager 1320, or a combination thereof) may support techniques for reduced power consumption and more efficient utilization of communication resources.

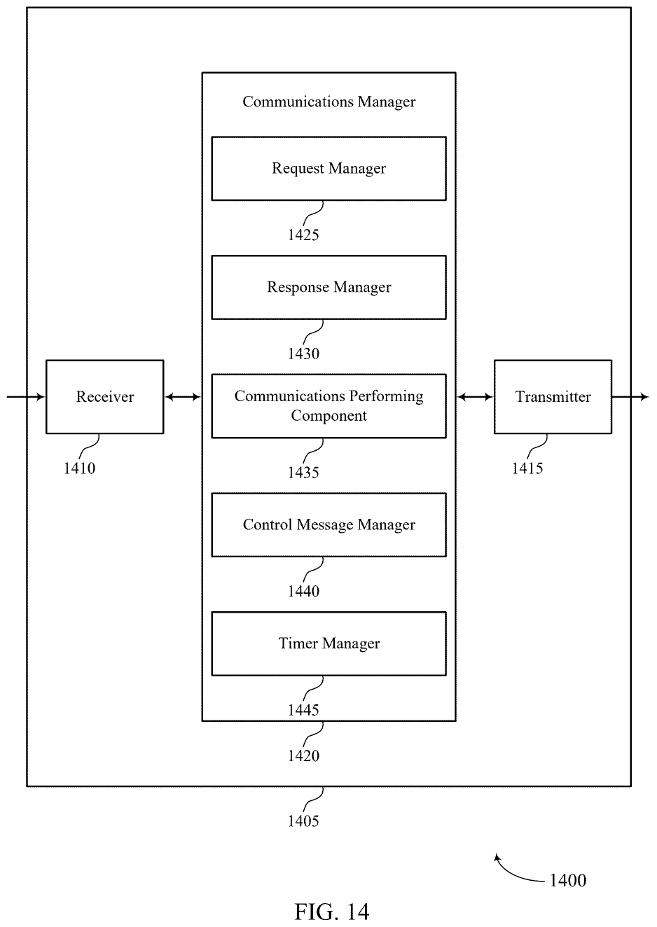

FIG. 14 shows a block diagram 1400 of a device 1405 that supports dynamic MIMO and carrier aggregation communication configurations in accordance with one or more aspects of the present disclosure. The device 1405 may be an example of aspects of a device 1305 or a network entity 105 as described herein. The device 1405 may include a receiver 1410, a transmitter 1415, and a communications manager 1420. The device 1405, or one or more components of the device 1405 (e.g., the receiver 1410, the transmitter 1415, the communications manager 1420), may include at least one processor, which may be coupled with at least one memory, to support the described techniques. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The device 1405, or various components thereof, may be an example of means for performing various aspects of dynamic MIMO and carrier aggregation communication configurations as described herein. For example, the communications manager 1420 may include a request manager 1425, a response manager 1430, a communications performing component 1435, a control message manager 1440, a timer manager 1445, or any combination thereof. The communications manager 1420 may be an example of aspects of a communications manager 1320 as described herein. In some examples, the communications manager 1420, or various components thereof, may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications in accordance with examples as disclosed herein. The request manager 1425 is capable of, configured to, or operable to support a means for obtaining a request message including a request to adjust one or more parameters associated with a MIMO configuration, a carrier aggregation configuration, or both, where obtaining the request message is in accordance with one or more capabilities of a UE. The response manager 1430 is capable of, configured to, or operable to support a means for outputting a response message in response to the request, where the response message indicates for the UE to adjust the one or more parameters in accordance with the request. The communications performing component 1435 is capable of, configured to, or operable to support a means for performing wireless communications in accordance with one or more adjusted parameters.

Additionally, or alternatively, the communications manager 1420 may support wireless communications in accordance with examples as disclosed herein. The control message manager 1440 is capable of, configured to, or operable to support a means for outputting a first control message indicating one or more timers associated with one or more parameters, the one or more parameters associated with a MIMO configuration, a carrier aggregation configuration, or both. The timer manager 1445 is capable of, configured to, or operable to support a means for initiating, in accordance with receiving the first control message, a first timer of the one or more timers in accordance with one or more triggering parameters satisfying a threshold and in accordance with outputting the first control message. The communications performing component 1435 is capable of, configured to, or operable to support a means for performing wireless communications in accordance with initiating the first timer and the MIMO configuration, the carrier aggregation configuration, or both to the one or more parameters.

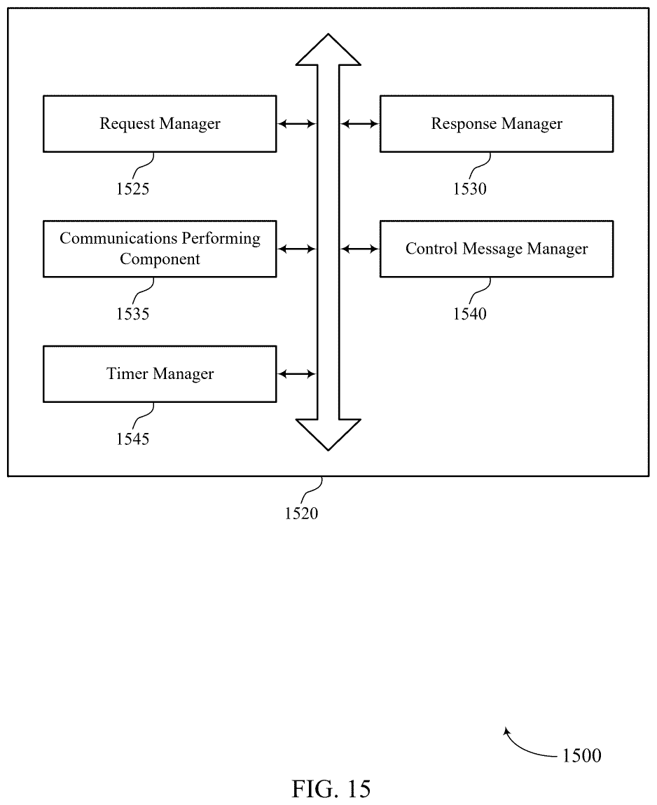

FIG. 15 shows a block diagram 1500 of a communications manager 1520 that supports dynamic MIMO and carrier aggregation communication configurations in accordance with one or more aspects of the present disclosure. The communications manager 1520 may be an example of aspects of a communications manager 1320, a communications manager 1420, or both, as described herein. The communications manager 1520, or various components thereof, may be an example of means for performing various aspects of dynamic MIMO and carrier aggregation communication configurations as described herein. For example, the communications manager 1520 may include a request manager 1525, a response manager 1530, a communications performing component 1535, a control message manager 1540, a timer manager 1545, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1520 may support wireless communications in accordance with examples as disclosed herein. The request manager 1525 is capable of, configured to, or operable to support a means for obtaining a request message including a request to adjust one or more parameters associated with a MIMO configuration, a carrier aggregation configuration, or both, where obtaining the request message is in accordance with one or more capabilities of a UE. The response manager 1530 is capable of, configured to, or operable to support a means for outputting a response message in response to the request, where the response message indicates for the UE to adjust the one or more parameters in accordance with the request. The communications performing component 1535 is capable of, configured to, or operable to support a means for performing wireless communications in accordance with one or more adjusted parameters.

In some examples, the one or more parameters include a quantity of transmit chains, a quantity of secondary downlink carriers, a quantity of secondary uplink carriers, activation or deactivation of one or more secondary downlink carriers of the secondary downlink carriers, activation or deactivation of one or more secondary uplink carriers of the secondary uplink carriers, activation or deactivation of one or more supplementary uplink carriers, or any combination thereof.

In some examples, the request message is obtained via UCI, a MAC-CE, or any combination thereof.

In some examples, the response message is output via DCI, a MAC-CE, or any combination thereof.

In some examples, the request to adjust the one or more parameters include a request to adjust at least one first parameter associated with the MIMO configuration and to adjust at least one second parameter associated with the carrier aggregation configuration. In some examples, the one or more parameters includes the at least one first parameter and the at least one second parameter.

Additionally, or alternatively, the communications manager 1520 may support wireless communications in accordance with examples as disclosed herein. The control message manager 1540 is capable of, configured to, or operable to support a means for outputting a first control message indicating one or more timers associated with one or more parameters, the one or more parameters associated with a MIMO configuration, a carrier aggregation configuration, or both. The timer manager 1545 is capable of, configured to, or operable to support a means for initiating, in accordance with receiving the first control message, a first timer of the one or more timers in accordance with one or more triggering parameters satisfying a threshold and in accordance with outputting the first control message. In some examples, the communications performing component 1535 is capable of, configured to, or operable to support a means for performing wireless communications in accordance with initiating the first timer and the MIMO configuration, the carrier aggregation configuration, or both corresponding to the one or more parameters.

In some examples, the control message manager 1540 is capable of, configured to, or operable to support a means for outputting, via the first control message or a second message, an indication of a set of multiple priority levels associated with one or more secondary carriers, where the one or more secondary carriers include one or more secondary uplink carriers, one or more secondary downlink carriers, or any combination thereof and where the one or more parameters include one or more secondary carriers.

In some examples, the request manager 1525 is capable of, configured to, or operable to support a means for obtaining a request message, via UCI or via a MAC-CE, including a request to increase the one or more parameters at a UE. In some examples, the response manager 1530 is capable of, configured to, or operable to support a means for outputting a message, via DCI or via a second MAC-CE, in response to the request, where the message indicates for the UE to increase the one or more parameters in accordance with obtaining the request message.

In some examples, the one or more parameters include a quantity of transmit chains, a quantity of secondary downlink carriers, a quantity of secondary uplink carriers, an activation or deactivation of one or more secondary downlink carriers, an activation or deactivation of one or more secondary uplink carriers, or any combination thereof.

In some examples, the first control message is transmitted via a system information block, radio resource control signaling, DCI, or any combination thereof.

In some examples, outputting the first control message is in accordance with one or more capabilities of a UE.

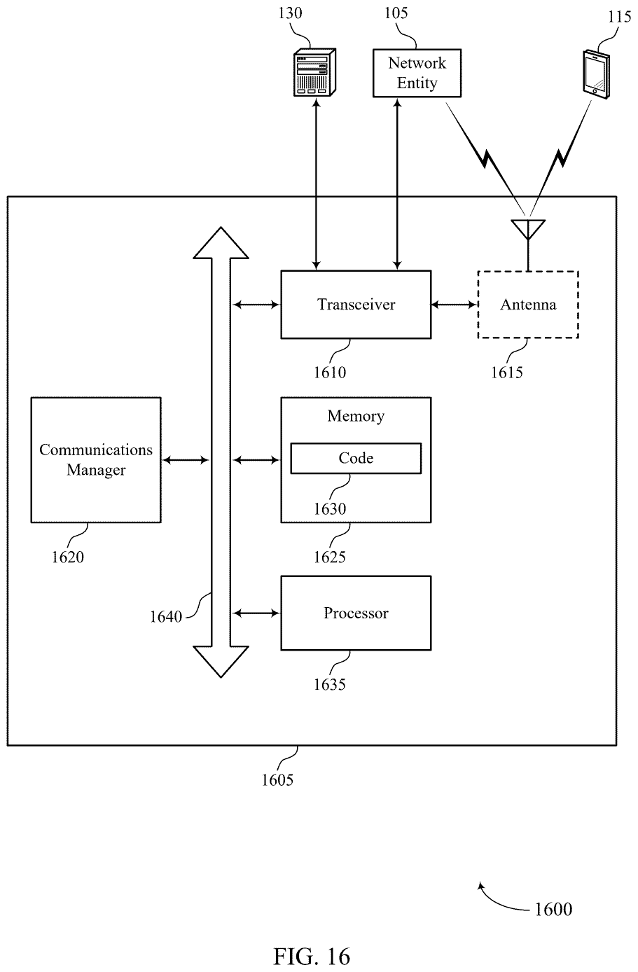

FIG. 16 shows a diagram of a system 1600 including a device 1605 that supports dynamic MIMO and carrier aggregation communication configurations in accordance with one or more aspects of the present disclosure. The device 1605 may be an example of or include components of a device 1305, a device 1405, or a network entity 105 as described herein. The device 1605 may communicate with other network devices or network equipment such as one or more of the network entities 105, UEs 115, or any combination thereof. The communications may include communications over one or more wired interfaces, over one or more wireless interfaces, or any combination thereof. The device 1605 may include components that support outputting and obtaining communications, such as a communications manager 1620, a transceiver 1610, one or more antennas 1615, at least one memory 1625, code 1630, and at least one processor 1635. These components may be in electronic communication or otherwise coupled (e.g., operatively, communicatively, functionally, electronically, electrically) via one or more buses (e.g., a bus 1640).

The transceiver 1610 may support bi-directional communications via wired links, wireless links, or both as described herein. In some examples, the transceiver 1610 may include a wired transceiver and may communicate bi-directionally with another wired transceiver. Additionally, or alternatively, in some examples, the transceiver 1610 may include a wireless transceiver and may communicate bi-directionally with another wireless transceiver. In some examples, the device 1605 may include one or more antennas 1615, which may be capable of transmitting or receiving wireless transmissions (e.g., concurrently). The transceiver 1610 may also include a modem to modulate signals, to provide the modulated signals for transmission (e.g., by one or more antennas 1615, by a wired transmitter), to receive modulated signals (e.g., from one or more antennas 1615, from a wired receiver), and to demodulate signals. In some implementations, the transceiver 1610 may include one or more interfaces, such as one or more interfaces coupled with the one or more antennas 1615 that are configured to support various receiving or obtaining operations, or one or more interfaces coupled with the one or more antennas 1615 that are configured to support various transmitting or outputting operations, or a combination thereof. In some implementations, the transceiver 1610 may include or be configured for coupling with one or more processors or one or more memory components that are operable to perform or support operations based on received or obtained information or signals, or to generate information or other signals for transmission or other outputting, or any combination thereof. In some implementations, the transceiver 1610, or the transceiver 1610 and the one or more antennas 1615, or the transceiver 1610 and the one or more antennas 1615 and one or more processors or one or more memory components (e.g., the at least one processor 1635, the at least one memory 1625, or both), may be included in a chip or chip assembly that is installed in the device 1605. In some examples, the transceiver 1610 may be operable to support communications via one or more communications links (e.g., communication link(s) 125, backhaul communication link(s) 120, a midhaul communication link 162, a fronthaul communication link 168).

The at least one memory 1625 may include RAM, ROM, or any combination thereof. The at least one memory 1625 may store computer-readable, computer-executable, or processor-executable code, such as the code 1630. The code 1630 may include instructions that, when executed by one or more of the at least one processor 1635, cause the device 1605 to perform various functions described herein. The code 1630 may be stored in a non-transitory computer-readable medium such as system memory or another type of memory. In some cases, the code 1630 may not be directly executable by a processor of the at least one processor 1635 but may cause a computer (e.g., when compiled and executed) to perform functions described herein. In some cases, the at least one memory 1625 may include, among other things, a BIOS which may control basic hardware or software operation such as the interaction with peripheral components or devices. In some examples, the at least one processor 1635 may include multiple processors and the at least one memory 1625 may include multiple memories. One or more of the multiple processors may be coupled with one or more of the multiple memories which may, individually or collectively, be configured to perform various functions herein (for example, as part of a processing system).

The at least one processor 1635 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1635 may be configured to operate a memory array using a memory controller. In some other cases, a memory controller may be integrated into one or more of the at least one processor 1635. The at least one processor 1635 may be configured to execute computer-readable instructions stored in a memory (e.g., one or more of the at least one memory 1625) to cause the device 1605 to perform various functions (e.g., functions or tasks supporting dynamic MIMO and carrier aggregation communication configurations). For example, the device 1605 or a component of the device 1605 may include at least one processor 1635 and at least one memory 1625 coupled with one or more of the at least one processor 1635, the at least one processor 1635 and the at least one memory 1625 configured to perform various functions described herein. The at least one processor 1635 may be an example of a cloud-computing platform (e.g., one or more physical nodes and supporting software such as operating systems, virtual machines, or container instances) that may host the functions (e.g., by executing code 1630) to perform the functions of the device 1605. The at least one processor 1635 may be any one or more suitable processors capable of executing scripts or instructions of one or more software programs stored in the device 1605 (such as within one or more of the at least one memory 1625).

In some examples, the at least one processor 1635 may include multiple processors and the at least one memory 1625 may include multiple memories. One or more of the multiple processors may be coupled with one or more of the multiple memories, which may, individually or collectively, be configured to perform various functions herein. In some examples, the at least one processor 1635 may be a component of a processing system, which may refer to a system (such as a series) of machines, circuitry (including, for example, one or both of processor circuitry (which may include the at least one processor 1635) and memory circuitry (which may include the at least one memory 1625)), or components, that receives or obtains inputs and processes the inputs to produce, generate, or obtain a set of outputs. The processing system may be configured to perform one or more of the functions described herein. For example, the at least one processor 1635 or a processing system including the at least one processor 1635 may be configured to, configurable to, or operable to cause the device 1605 to perform one or more of the functions described herein. Further, as described herein, being “configured to,” being “configurable to,” and being “operable to” may be used interchangeably and may be associated with a capability, when executing code stored in the at least one memory 1625 or otherwise, to perform one or more of the functions described herein.

In some examples, a bus 1640 may support communications of (e.g., within) a protocol layer of a protocol stack. In some examples, a bus 1640 may support communications associated with a logical channel of a protocol stack (e.g., between protocol layers of a protocol stack), which may include communications performed within a component of the device 1605, or between different components of the device 1605 that may be co-located or located in different locations (e.g., where the device 1605 may refer to a system in which one or more of the communications manager 1620, the transceiver 1610, the at least one memory 1625, the code 1630, and the at least one processor 1635 may be located in one of the different components or divided between different components).

In some examples, the communications manager 1620 may manage aspects of communications with a core network 130 (e.g., via one or more wired or wireless backhaul links). For example, the communications manager 1620 may manage the transfer of data communications for client devices, such as one or more UEs 115. In some examples, the communications manager 1620 may manage communications with one or more other network entities 105, and may include a controller or scheduler for controlling communications with UEs 115 (e.g., in cooperation with the one or more other network devices). In some examples, the communications manager 1620 may support an X2 interface within an LTE/LTE-A wireless communications network technology to provide communication between network entities 105.

The communications manager 1620 may support wireless communications in accordance with examples as disclosed herein. For example, the communications manager 1620 is capable of, configured to, or operable to support a means for obtaining a request message including a request to adjust one or more parameters associated with a MIMO configuration, a carrier aggregation configuration, or both, where obtaining the request message is in accordance with one or more capabilities of a UE. The communications manager 1620 is capable of, configured to, or operable to support a means for outputting a response message in response to the request, where the response message indicates for the UE to adjust the one or more parameters in accordance with the request. The communications manager 1620 is capable of, configured to, or operable to support a means for performing wireless communications in accordance with one or more adjusted parameters.

Additionally, or alternatively, the communications manager 1620 may support wireless communications in accordance with examples as disclosed herein. For example, the communications manager 1620 is capable of, configured to, or operable to support a means for outputting a first control message indicating one or more timers associated with one or more parameters, the one or more parameters associated with a MIMO configuration, a carrier aggregation configuration, or both. The communications manager 1620 is capable of, configured to, or operable to support a means for initiating, in accordance with receiving the first control message, a first timer of the one or more timers in accordance with one or more triggering parameters satisfying a threshold and in accordance with outputting the first control message. The communications manager 1620 is capable of, configured to, or operable to support a means for performing wireless communications in accordance with initiating the first timer and the MIMO configuration, the carrier aggregation configuration, or both corresponding to the one or more parameters.

By including or configuring the communications manager 1620 in accordance with examples as described herein, the device 1605 may support techniques for reduced latency, reduced power consumption, more efficient utilization of communication resources, improved coordination between devices, longer battery life, and improved utilization of processing capability.

In some examples, the communications manager 1620 may be configured to perform various operations (e.g., receiving, obtaining, monitoring, outputting, transmitting) using or otherwise in cooperation with the transceiver 1610, the one or more antennas 1615 (e.g., where applicable), or any combination thereof. Although the communications manager 1620 is illustrated as a separate component, in some examples, one or more functions described with reference to the communications manager 1620 may be supported by or performed by the transceiver 1610, one or more of the at least one processor 1635, one or more of the at least one memory 1625, the code 1630, or any combination thereof (for example, by a processing system including at least a portion of the at least one processor 1635, the at least one memory 1625, the code 1630, or any combination thereof). For example, the code 1630 may include instructions executable by one or more of the at least one processor 1635 to cause the device 1605 to perform various aspects of dynamic MIMO and carrier aggregation communication configurations as described herein, or the at least one processor 1635 and the at least one memory 1625 may be otherwise configured to, individually or collectively, perform or support such operations.

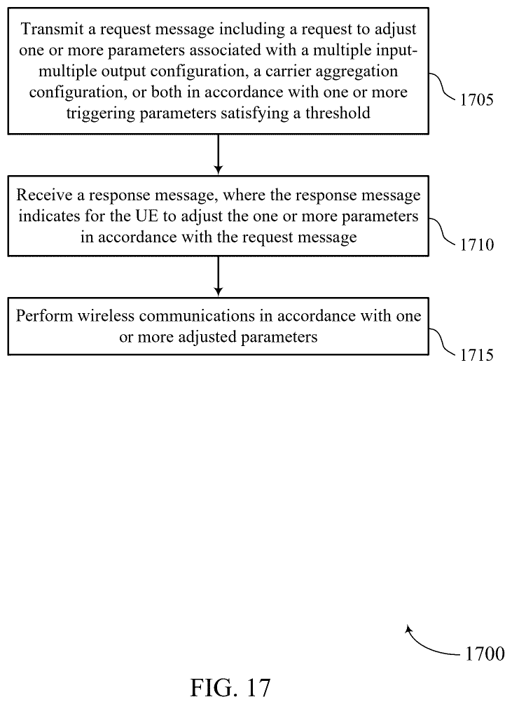

FIG. 17 shows a flowchart illustrating a method 1700 that supports dynamic MIMO and carrier aggregation communication configurations in accordance with one or more aspects of the present disclosure. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1705, the method may include transmitting a request message including a request to adjust one or more parameters associated with a MIMO configuration, a carrier aggregation configuration, or both in accordance with one or more triggering parameters satisfying a threshold. The operations of 1705 may be performed in accordance with examples as disclosed herein. In some examples, aspects of the operations of 1705 may be performed by a request manager 1125 as described with reference to FIG. 11.

At 1710, the method may include receiving a response message, where the response message indicates for the UE to adjust the one or more parameters in accordance with the request message. The operations of 1710 may be performed in accordance with examples as disclosed herein. In some examples, aspects of the operations of 1710 may be performed by a response manager 1130 as described with reference to FIG. 11.

At 1715, the method may include performing wireless communications in accordance with one or more adjusted parameters. The operations of 1715 may be performed in accordance with examples as disclosed herein. In some examples, aspects of the operations of 1715 may be performed by a communications performing component 1135 as described with reference to FIG. 11.

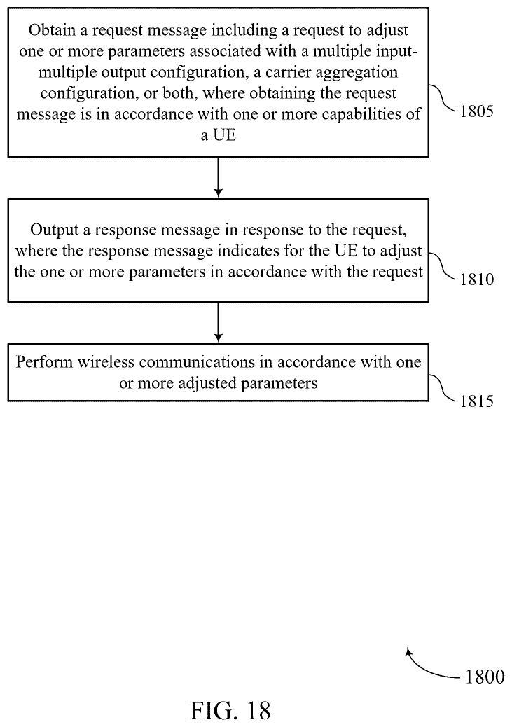

FIG. 18 shows a flowchart illustrating a method 1800 that supports dynamic MIMO and carrier aggregation communication configurations in accordance with one or more aspects of the present disclosure. The operations of the method 1800 may be implemented by a network entity or its components as described herein. For example, the operations of the method 1800 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 1805, the method may include obtaining a request message including a request to adjust one or more parameters associated with a MIMO configuration, a carrier aggregation configuration, or both, where obtaining the request message is in accordance with one or more capabilities of a UE. The operations of 1805 may be performed in accordance with examples as disclosed herein. In some examples, aspects of the operations of 1805 may be performed by a request manager 1525 as described with reference to FIG. 15.

At 1810, the method may include outputting a response message in response to the request, where the response message indicates for the UE to adjust the one or more parameters in accordance with the request. The operations of 1810 may be performed in accordance with examples as disclosed herein. In some examples, aspects of the operations of 1810 may be performed by a response manager 1530 as described with reference to FIG. 15.

At 1815, the method may include performing wireless communications in accordance with one or more adjusted parameters. The operations of 1815 may be performed in accordance with examples as disclosed herein. In some examples, aspects of the operations of 1815 may be performed by a communications performing component 1535 as described with reference to FIG. 15.

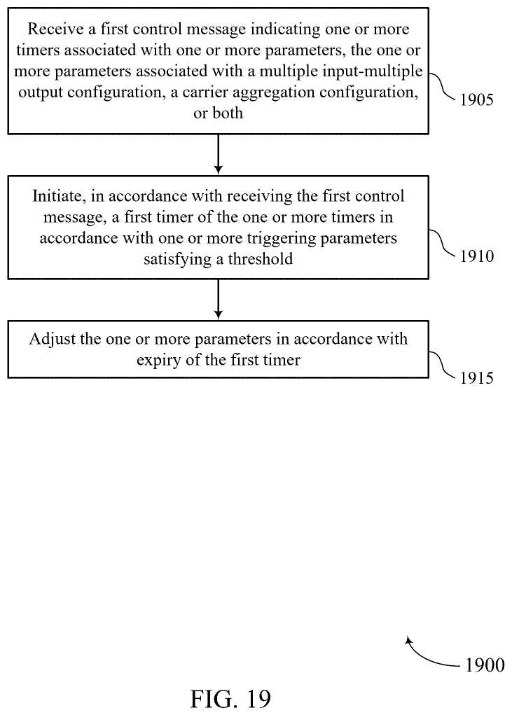

FIG. 19 shows a flowchart illustrating a method 1900 that supports dynamic MIMO and carrier aggregation communication configurations in accordance with one or more aspects of the present disclosure. The operations of the method 1900 may be implemented by a UE or its components as described herein. For example, the operations of the method 1900 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1905, the method may include receiving a first control message indicating one or more timers associated with one or more parameters, the one or more parameters associated with a MIMO configuration, a carrier aggregation configuration, or both. The operations of 1905 may be performed in accordance with examples as disclosed herein. In some examples, aspects of the operations of 1905 may be performed by a control message manager 1140 as described with reference to FIG. 11.

At 1910, the method may include initiating, in accordance with receiving the first control message, a first timer of the one or more timers in accordance with one or more triggering parameters satisfying a threshold. The operations of 1910 may be performed in accordance with examples as disclosed herein. In some examples, aspects of the operations of 1910 may be performed by a timer manager 1145 as described with reference to FIG. 11.

At 1915, the method may include adjusting the one or more parameters in accordance with expiry of the first timer. The operations of 1915 may be performed in accordance with examples as disclosed herein. In some examples, aspects of the operations of 1915 may be performed by a parameter adjuster 1150 as described with reference to FIG. 11.

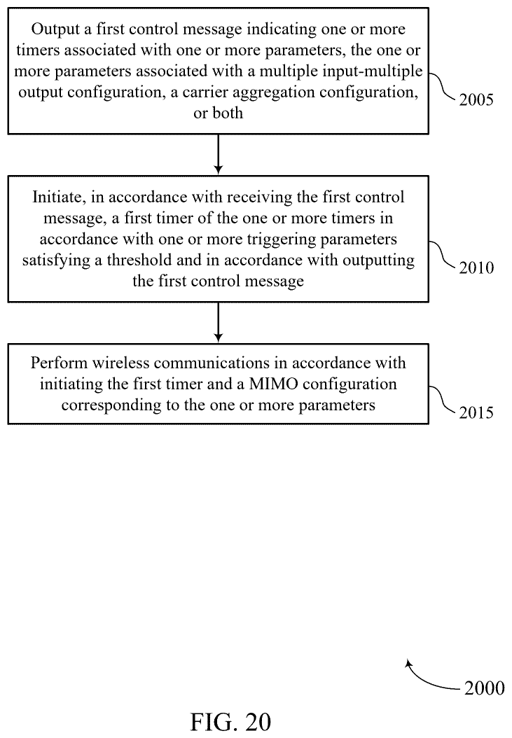

FIG. 20 shows a flowchart illustrating a method 2000 that supports dynamic MIMO and carrier aggregation communication configurations in accordance with one or more aspects of the present disclosure. The operations of the method 2000 may be implemented by a network entity or its components as described herein. For example, the operations of the method 2000 may be performed by a network entity as described with reference to FIGS. 1 through 8 and 13 through 16. In some examples, a network entity may execute a set of instructions to control the functional elements of the network entity to perform the described functions. Additionally, or alternatively, the network entity may perform aspects of the described functions using special-purpose hardware.

At 2005, the method may include outputting a first control message indicating one or more timers associated with one or more parameters, the one or more parameters associated with a MIMO configuration, a carrier aggregation configuration, or both. The operations of 2005 may be performed in accordance with examples as disclosed herein. In some examples, aspects of the operations of 2005 may be performed by a control message manager 1540 as described with reference to FIG. 15.

At 2010, the method may include initiating, in accordance with receiving the first control message, a first timer of the one or more timers in accordance with one or more triggering parameters satisfying a threshold and in accordance with outputting the first control message. The operations of 2010 may be performed in accordance with examples as disclosed herein. In some examples, aspects of the operations of 2010 may be performed by a timer manager 1545 as described with reference to FIG. 15.

At 2015, the method may include performing wireless communications in accordance with initiating the first timer and the MIMO configuration, the carrier aggregation configuration, or both corresponding to the one or more parameters. The operations of 2015 may be performed in accordance with examples as disclosed herein. In some examples, aspects of the operations of 2015 may be performed by a communications performing component 1535 as described with reference to FIG. 15.

The following provides an overview of aspects of the present disclosure:
Aspect 1: A method for wireless communications at a UE, comprising: transmitting a request message comprising a request to adjust one or more parameters associated with a MIMO configuration, a carrier aggregation configuration, or both in accordance with one or more triggering parameters satisfying a threshold; receiving a response message, wherein the response message indicates for the UE to adjust the one or more parameters in accordance with the request message; and performing wireless communications in accordance with one or more adjusted parameters.
Aspect 2: The method of aspect 1, further comprising: adjusting the one or more parameters to the one or more adjusted parameters in accordance with receiving the response message, wherein performing the wireless communications is in accordance with adjusting the one or more parameters.
Aspect 3: The method of any of aspects 1 through 2, further comprising: tracking a plurality of triggering parameters at the UE, wherein the plurality of triggering parameters comprises the one or more triggering parameters and transmitting the request message is in accordance with the one or more triggering parameters of the plurality of triggering parameters satisfying the threshold.
Aspect 4: The method of aspect 3, wherein the plurality of triggering parameters comprise an uplink data rate, one or more latency thresholds, one or more channel conditions at the UE, power consumption at the UE, one or more application-based data rates, one or more application-based latency thresholds, a position of the UE, or any combination thereof, the one or more channel conditions comprise an uplink transmission power, a channel path loss, a MCS allocation, a resource block allocation, or any combination thereof.
Aspect 5: The method of any of aspects 3 through 4, wherein tracking the plurality of triggering parameters at the UE further comprises: inputting one or more detected triggering parameter values associated with the plurality of triggering parameters into a ML model, wherein an output of the ML model corresponds to the one or more parameters.
Aspect 6: The method of any of aspects 1 through 5, wherein the one or more parameters comprise a quantity of transmit chains, a quantity of secondary downlink carriers, a quantity of secondary uplink carriers, activation or deactivation of one or more secondary downlink carriers of the secondary downlink carriers, activation or deactivation of one or more secondary uplink carriers of the secondary uplink carriers, activation or deactivation of one or more SUL carriers, or any combination thereof.
Aspect 7: The method of any of aspects 1 through 6, wherein the request message is transmitted via UCI or a MAC-CE.
Aspect 8: The method of any of aspects 1 through 7, wherein the response message is received via DCI or a MAC-CE.
Aspect 9: The method of any of aspects 1 through 8, wherein the request to adjust the one or more parameters comprise a request to adjust at least one first parameter associated with the MIMO configuration and to adjust at least one second parameter associated with the carrier aggregation configuration, the one or more parameters comprises the at least one first parameter and the at least one second parameter.
Aspect 10: A method for wireless communications at a network entity, comprising: obtaining a request message comprising a request to adjust one or more parameters associated with a MIMO configuration, a carrier aggregation configuration, or both, wherein obtaining the request message is in accordance with one or more capabilities of a UE; outputting a response message in response to the request, wherein the response message indicates for the UE to adjust the one or more parameters in accordance with the request; and performing wireless communications in accordance with one or more adjusted parameters.
Aspect 11: The method of aspect 10, wherein the one or more parameters comprise a quantity of transmit chains, a quantity of secondary downlink carriers, a quantity of secondary uplink carriers, activation or deactivation of one or more secondary downlink carriers of the secondary downlink carriers, activation or deactivation of one or more secondary uplink carriers of the secondary uplink carriers, activation or deactivation of one or more SUL carriers, or any combination thereof.
Aspect 12: The method of any of aspects 10 through 11, wherein the request message is obtained via UCI, a MAC-CE message, or any combination thereof.
Aspect 13: The method of any of aspects 10 through 12, wherein the response message is output via DCI, a MAC-CE message, or any combination thereof.
Aspect 14: The method of any of aspects 10 through 13, the request to adjust the one or more parameters comprise a request to adjust at least one first parameter associated with the MIMO configuration and to adjust at least one second parameter associated with the carrier aggregation configuration, wherein the one or more parameters comprises the at least one first parameter and the at least one second parameter.
Aspect 15: A method for wireless communications at a UE, comprising: receiving a first control message indicating one or more timers associated with one or more parameters, the one or more parameters associated with a MIMO configuration, a carrier aggregation configuration, or both; initiating, in accordance with receiving the first control message, a first timer of the one or more timers in accordance with one or more triggering parameters satisfying a threshold; and adjusting the one or more parameters in accordance with expiry of the first timer.
Aspect 16: The method of aspect 15, further comprising: tracking the one or more triggering parameters at the UE, wherein the one or more triggering parameters comprise an uplink data rate, one or more latency thresholds, one or more channel conditions at the UE, power consumption at the UE, one or more application-based data rates, one or more application-based latency thresholds, a position of the UE, or any combination thereof, wherein the one or more channel conditions comprise an uplink transmission power, a channel path loss, a MCS allocation, a resource block allocation, or any combination thereof.
Aspect 17: The method of aspect 16, wherein tracking the one or more triggering parameters at the UE further comprises: inputting one or more detected triggering parameter values associated with the one or more triggering parameters into a ML model, wherein an output of the ML model corresponds to the one or more parameters.
Aspect 18: The method of any of aspects 15 through 17, further comprising: transmitting a request message, via UCI or via a MAC-CE, comprising a request to increase the one or more parameters; and receiving a response message, via DCI or via a second MAC-CE, in response to the request, wherein the response message indicates for the UE to increase the one or more parameters in accordance with the request message.
Aspect 19: The method of any of aspects 15 through 18, wherein adjusting the one or more parameters comprises: decreasing a quantity of transmit chains, decreasing a quantity of secondary carriers, deactivation of one or more secondary carriers, or any combination thereof in accordance with the expiry of the first timer, wherein the secondary carriers comprise one or more secondary downlink carriers, one or more secondary uplink carriers, or any combination thereof.
Aspect 20: The method of any of aspects 15 through 19, wherein the one or more parameters comprise one or more secondary carriers and wherein adjusting the one or more parameters comprises: receiving, via the first control message or a second message, an indication of a plurality of priority levels associated with the one or more secondary carriers, wherein the one or more secondary carriers comprise one or more secondary uplink carriers, one or more secondary downlink carriers, or any combination thereof; and deactivating at least one secondary carrier of the one or more secondary carriers in accordance with the plurality of priority levels and in accordance with the expiry of the first timer.
Aspect 21: The method of any of aspects 15 through 20, wherein the one or more parameters comprise a quantity of transmission chains and wherein adjusting the one or more parameters comprises: decreasing the quantity of transmit chains from a first quantity to a second quantity in accordance with the expiry of the first timer of the one or more timers, wherein the second quantity is associated with the first timer; and decreasing the quantity of transmit chains from the second quantity to a third quantity in accordance with expiry of a second timer of the one or more timers, wherein the third quantity is associated with the second timer.
Aspect 22: The method of any of aspects 15 through 21, wherein the one or more parameters comprise a quantity of transmission chains and wherein adjusting the one or more parameters comprises: decreasing the quantity of transmit chains to a threshold quantity after expiry of the first timer; and transitioning from a first MIMO configuration to a second MIMO configuration in accordance with decreasing the quantity of transmit chains to the threshold quantity.
Aspect 23: The method of any of aspects 15 through 22, further comprising: adjusting the one or more parameters in accordance with expiry of a second timer of the one or more timers, the second timer different from the first timer.
Aspect 24: The method of any of aspects 15 through 23, wherein the first control message comprises a SIB, RRC signaling, DCI, or any combination thereof.
Aspect 25: A method for wireless communications at a network entity, comprising: outputting a first control message indicating one or more timers associated with one or more parameters, the one or more parameters associated with a MIMO configuration, a carrier aggregation configuration, or both; initiating, in accordance with receiving the first control message, a first timer of the one or more timers in accordance with one or more triggering parameters satisfying a threshold and in accordance with outputting the first control message; and performing wireless communications in accordance with initiating the first timer and the MIMO configuration, the carrier aggregation configuration, or both corresponding to the one or more parameters.
Aspect 26: The method of aspect 25, the one or more parameters comprises one or more secondary carriers and further comprising: outputting, via the first control message or a second message, an indication of a plurality of priority levels associated with one or more secondary carriers, wherein the one or more secondary carriers comprise one or more secondary uplink carriers, one or more secondary downlink carriers, or any combination thereof.
Aspect 27: The method of any of aspects 25 through 26, further comprising: obtaining a request message, via UCI or via a MAC-CE, comprising a request to increase the one or more parameters at a UE; and outputting a message, via DCI or via a second MAC-CE, in response to the request, wherein the message indicates for the UE to increase the one or more parameters in accordance with obtaining the request message.
Aspect 28: The method of any of aspects 25 through 27, wherein the one or more parameters comprise a quantity of transmit chains, a quantity of secondary downlink carriers, a quantity of secondary uplink carriers, an activation or deactivation of one or more secondary downlink carriers, an activation or deactivation of one or more secondary uplink carriers, or any combination thereof.
Aspect 29: The method of any of aspects 25 through 28, wherein the first control message is transmitted via a SIB, RRC signaling, DCI, or any combination thereof.
Aspect 30: The method of any of aspects 25 through 29, wherein outputting the first control message is in accordance with one or more capabilities of a UE.
Aspect 31: A UE for wireless communications, comprising one or more memories storing processor-executable code, and one or more processors coupled with the one or more memories and individually or collectively operable to execute the code to cause the UE to perform a method of any of aspects 1 through 9.
Aspect 32: A UE for wireless communications, comprising at least one means for performing a method of any of aspects 1 through 9.
Aspect 33: A non-transitory computer-readable medium storing code for wireless communications, the code comprising instructions executable by one or more processors to perform a method of any of aspects 1 through 9.
Aspect 34: A network entity for wireless communications, comprising one or more memories storing processor-executable code, and one or more processors coupled with the one or more memories and individually or collectively operable to execute the code to cause the network entity to perform a method of any of aspects 10 through 14.
Aspect 35: A network entity for wireless communications, comprising at least one means for performing a method of any of aspects 10 through 14.
Aspect 36: A non-transitory computer-readable medium storing code for wireless communications, the code comprising instructions executable by one or more processors to perform a method of any of aspects 10 through 14.
Aspect 37: A UE for wireless communications, comprising one or more memories storing processor-executable code, and one or more processors coupled with the one or more memories and individually or collectively operable to execute the code to cause the UE to perform a method of any of aspects 15 through 24.
Aspect 38: A UE for wireless communications, comprising at least one means for performing a method of any of aspects 15 through 24.
Aspect 39: A non-transitory computer-readable medium storing code for wireless communications, the code comprising instructions executable by one or more processors to perform a method of any of aspects 15 through 24.
Aspect 40: A network entity for wireless communications, comprising one or more memories storing processor-executable code, and one or more processors coupled with the one or more memories and individually or collectively operable to execute the code to cause the network entity to perform a method of any of aspects 25 through 30.
Aspect 41: A network entity for wireless communications, comprising at least one means for performing a method of any of aspects 25 through 30.
Aspect 42: A non-transitory computer-readable medium storing code for wireless communications, the code comprising instructions executable by one or more processors to perform a method of any of aspects 25 through 30.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit a request message comprising a request to adjust one or more parameters associated with a multiple input-multiple output configuration, a carrier aggregation configuration, or both in accordance with one or more triggering parameters satisfying a threshold;
receive a response message, wherein the response message indicates for the UE to adjust the one or more parameters in accordance with the request message; and
perform wireless communications in accordance with one or more adjusted parameters.

2. The UE of claim 1, wherein the one or more processors are individually or collectively further operable to execute the code to cause the UE to:
adjust the one or more parameters to the one or more adjusted parameters in accordance with receiving the response message, wherein performing the wireless communications is in accordance with adjusting the one or more parameters.

3. The UE of claim 1, wherein the one or more processors are individually or collectively further operable to execute the code to cause the UE to:
track a plurality of triggering parameters at the UE, wherein the plurality of triggering parameters comprises the one or more triggering parameters and transmitting the request message is in accordance with the one or more triggering parameters of the plurality of triggering parameters satisfying the threshold.

4. The UE of claim 3, wherein:
the plurality of triggering parameters comprise an uplink data rate, one or more latency thresholds, one or more channel conditions at the UE, power consumption at the UE, one or more application-based data rates, one or more application-based latency thresholds, a position of the UE, or any combination thereof, wherein the one or more channel conditions comprise an uplink transmission power, a channel path loss, a modulation and coding scheme allocation, a resource block allocation, or any combination thereof.

5. The UE of claim 3, wherein, to track the plurality of triggering parameters at the UE, the one or more processors are individually or collectively further operable to execute the code to cause the UE to:
input one or more detected triggering parameter values associated with the plurality of triggering parameters into a machine learning model, wherein an output of the machine learning model corresponds to the one or more parameters.

6. The UE of claim 1, wherein the one or more parameters comprise a quantity of transmit chains, a quantity of secondary downlink carriers, a quantity of secondary uplink carriers, activation or deactivation of one or more secondary downlink carriers of the secondary downlink carriers, activation or deactivation of one or more secondary uplink carriers of the secondary uplink carriers, activation or deactivation of one or more supplementary uplink carriers, or any combination thereof.

7. The UE of claim 1, wherein the request message is transmitted via uplink control information or a medium access control-control element.

8. The UE of claim 1, wherein the response message is received via downlink control information or a medium access control-control element.

9. The UE of claim 1, wherein:
the request to adjust the one or more parameters comprise a request to adjust at least one first parameter associated with the multiple input-multiple output configuration and to adjust at least one second parameter associated with the carrier aggregation configuration, wherein the one or more parameters comprises the at least one first parameter and the at least one second parameter.

10. A network entity, comprising:
one or more memories storing processor-executable code; and
one or more processors coupled with the one or more memories and individually or collectively operable to execute the code to cause the network entity to:
obtain a request message comprising a request to adjust one or more parameters associated with a multiple input-multiple output configuration, a carrier aggregation configuration, or both, wherein obtaining the request message is in accordance with one or more capabilities of a user equipment (UE);
output a response message in response to the request, wherein the response message indicates for the UE to adjust the one or more parameters in accordance with the request; and
perform wireless communications in accordance with one or more adjusted parameters.

11. The network entity of claim 10, wherein the one or more parameters comprise a quantity of transmit chains, a quantity of secondary downlink carriers, a quantity of secondary uplink carriers, activation or deactivation of one or more secondary downlink carriers of the secondary downlink carriers, activation or deactivation of one or more secondary uplink carriers of the secondary uplink carriers, activation or deactivation of one or more supplementary uplink carriers, or any combination thereof.

12. The network entity of claim 10, wherein the request message is obtained via uplink control information, a medium access control-control element message, or any combination thereof.

13. The network entity of claim 10, wherein the response message is output via downlink control information, a medium access control-control element message, or any combination thereof.

14. The network entity of claim 10, wherein:
the request to adjust the one or more parameters comprise a request to adjust at least one first parameter associated with the multiple input-multiple output configuration and to adjust at least one second parameter associated with the carrier aggregation configuration, wherein the one or more parameters comprises the at least one first parameter and the at least one second parameter.

15. A user equipment (UE), comprising:
one or more memories storing processor-executable code; and
one or more processors coupled with the one or more memories and individually or collectively operable to execute the code to cause the UE to:
receive a first control message indicating one or more timers associated with one or more parameters, the one or more parameters associated with a multiple input-multiple output configuration, a carrier aggregation configuration, or both;
initiate, in accordance with receiving the first control message, a first timer of the one or more timers in accordance with one or more triggering parameters satisfying a threshold; and
adjust the one or more parameters in accordance with expiry of the first timer.

16. The UE of claim 15, wherein the one or more processors are individually or collectively further operable to execute the code to cause the UE to:
track the one or more triggering parameters at the UE, wherein the one or more triggering parameters comprise an uplink data rate, one or more latency thresholds, one or more channel conditions at the UE, power consumption at the UE, one or more application-based data rates, one or more application-based latency thresholds, a position of the UE, or any combination thereof, wherein the one or more channel conditions comprise an uplink transmission power, a channel path loss, a modulation and coding scheme allocation, a resource block allocation, or any combination thereof.

17. The UE of claim 16, wherein, to track the one or more triggering parameters at the UE, the one or more processors are individually or collectively further operable to execute the code to cause the UE to:
input one or more detected triggering parameter values associated with the one or more triggering parameters into a machine learning model, wherein an output of the machine learning model corresponds to the one or more parameters.

18. The UE of claim 15, wherein the one or more processors are individually or collectively further operable to execute the code to cause the UE to:
transmit a request message, via uplink control information or via a medium access control-control element (MAC-CE), comprising a request to increase the one or more parameters; and
receive a response message, via downlink control information or via a second MAC-CE, in response to the request, wherein the response message indicates for the UE to increase the one or more parameters in accordance with the request message.

19. The UE of claim 15, wherein, to adjust the one or more parameters, the one or more processors are individually or collectively operable to execute the code to cause the UE to:
decrease a quantity of transmit chains, decreasing a quantity of secondary carriers, deactivation of one or more secondary carriers, or any combination thereof in accordance with the expiry of the first timer, wherein the secondary carriers comprise one or more secondary downlink carriers, one or more secondary uplink carriers, or any combination thereof.

20. The UE of claim 15, wherein the one or more parameters comprise one or more secondary carriers and wherein, to adjust the one or more parameters, the one or more processors are individually or collectively operable to execute the code to cause the UE to:
receive, via the first control message or a second message, an indication of a plurality of priority levels associated with the one or more secondary carriers, wherein the one or more secondary carriers comprise one or more secondary uplink carriers, one or more secondary downlink carriers, or any combination thereof; and
deactivate at least one secondary carrier of the one or more secondary carriers in accordance with the plurality of priority levels and in accordance with the expiry of the first timer.

21. The UE of claim 15, wherein the one or more parameters comprise a quantity of transmit chains and wherein, to adjust the one or more parameters, the one or more processors are individually or collectively operable to execute the code to cause the UE to:
decrease the quantity of transmit chains from a first quantity to a second quantity in accordance with the expiry of the first timer of the one or more timers, wherein the second quantity is associated with the first timer; and
decrease the quantity of transmit chains from the second quantity to a third quantity in accordance with expiry of a second timer of the one or more timers, wherein the third quantity is associated with the second timer.

22. The UE of claim 15, wherein the one or more parameters comprises a quantity of transmit chains and wherein, to adjust the one or more parameters, the one or more processors are individually or collectively operable to execute the code to cause the UE to:
decrease the quantity of transmit chains to a threshold quantity after expiry of the first timer; and
transition from a first multiple input-multiple output configuration to a second multiple input-multiple output configuration in accordance with decreasing the quantity of transmit chains to the threshold quantity.

23. The UE of claim 15, wherein the one or more processors are individually or collectively further operable to execute the code to cause the UE to:
adjust the one or more parameters in accordance with expiry of a second timer of the one or more timers, the second timer different from the first timer.

24. The UE of claim 15, wherein the first control message comprises a system information block, radio resource control signaling, downlink control information, or any combination thereof.

25. A network entity, comprising:
one or more memories storing processor-executable code; and
one or more processors coupled with the one or more memories and individually or collectively operable to execute the code to cause the network entity to:
output a first control message indicating one or more timers associated with one or more parameters, the one or more parameters associated with a multiple input-multiple output configuration, a carrier aggregation configuration, or both;
initiate, in accordance with receiving the first control message, a first timer of the one or more timers in accordance with one or more triggering parameters satisfying a threshold and in accordance with outputting the first control message; and
perform wireless communications in accordance with initiating the first timer and the multiple input-multiple output configuration, the carrier aggregation configuration, or both corresponding to the one or more parameters.

26. The network entity of claim 25, wherein the one or more parameters comprises one or more secondary carriers and wherein the one or more processors are individually or collectively further operable to execute the code to cause the network entity to:
output, via the first control message or a second message, an indication of a plurality of priority levels associated with the one or more secondary carriers, wherein the one or more secondary carriers comprise one or more secondary uplink carriers, one or more secondary downlink carriers, or any combination thereof.

27. The network entity of claim 25, wherein the one or more processors are individually or collectively further operable to execute the code to cause the network entity to:
obtain a request message, via uplink control information or via a medium access control-control element (MAC-CE), comprising a request to increase the one or more parameters at a user equipment (UE); and
output a message, via downlink control information or via a second MAC-CE, in response to the request, wherein the message indicates for the UE to increase the one or more parameters in accordance with obtaining the request message.

28. The network entity of claim 25, wherein the one or more parameters comprise a quantity of transmit chains, a quantity of secondary downlink carriers, a quantity of secondary uplink carriers, an activation or deactivation of one or more secondary downlink carriers, an activation or deactivation of one or more secondary uplink carriers, or any combination thereof.

29. The network entity of claim 25, wherein the first control message is transmitted via a system information block, radio resource control signaling, downlink control information, or any combination thereof.

30. The network entity of claim 25, wherein outputting the first control message is in accordance with one or more capabilities of a user equipment (UE).
